(19) United States
(12) Patent Application Publication
(10) Pub. No.: US 2026/0286020 A1
(43) Pub. Date: Sep. 24, 2026

(54) OLEFIN POLYMERIZATION WITH DINUCLEAR CATALYSTS

(71) Applicant: EXXONMOBIL TECHNOLOGY AND ENGINEERING COMPANY, Spring, TX (US)

(72) Inventors: Lewis C. WILKINS, Baytown, TX (US); Michelle E. TITONE, La Porte, TX (US)

(73) Assignee: EXXONMOBIL TECHNOLOGY AND ENGINEERING COMPANY, Spring, TX (US)

(21) Appl. No.: 19/571,281

(22) Filed: Mar. 18, 2026

Related U.S. Application Data
(60) Provisional application No. 63/775,511, filed on Mar. 21, 2025.

(51) Int. Cl. C08F 10/02; C07F 9/00; C07F 15/02; C07F 15/06; C07F 19/00

(52) U.S. Cl. CPC C08F 10/02; C07F 9/005; C07F 15/025; C07F 15/065; C07F 19/005

(57) ABSTRACT

A catalyst compound represented by Formula (I) wherein: M¹ and M² are selected from magnesium, vanadium, niobium, tantalum, chromium, manganese, iron, cobalt, zinc, aluminum, gallium or indium, X¹ and X² are an anionic ligand, J¹ and J² are a neutral coordinated ligand bonded to M¹, M² or X, L is a divalent hydrocarbyl or substituted hydrocarbyl tether; n is 0, 1, 2 or 3, m is 0, 1, 2 or 3, and n+m is 1, 2, 3 or 4. The catalyst compound wherein any two X¹ may be joined together and any two X² may be joined together to each form a dianionic bidentate group, any two J¹ and/or any two J² may be joined together to each form a neutral bidentate group, and any X¹ and J¹ may be joined together and any two X² and J² may be joined together to each form a monoanionic bidentate group.

### FIELD

Embodiments of the present disclosure generally relate to catalysts for olefin polymerization. In particular, embodiments provided herein relate to compositions of catalysts, that may be include dinuclear tethered catalysts.

### BACKGROUND

Polyolefins (e.g., polyethylene polypropylene, and the like) and compositions containing polyolefins are used in various applications such as films, fibers, pipes, coatings, molded articles, and the like. Certain functional attributes (e.g., mechanical properties, strength, toughness, and compatibilization) may be modified to produce products with increased commercial viability. However, optimum performance of products may be generated by trading off one functional attribute for another. Catalyst design may be explored to improve production of polyolefins and products made thereof with optimized performance. As such, there is a need for improved catalysts to facilitate polymerization of olefins for improved industrial production of polyolefin based products.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a catalyst compound represented by Formula (I):

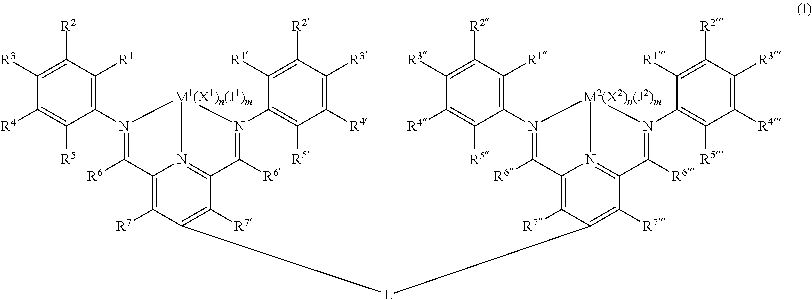

wherein: M¹ and M² are independently selected from magnesium, vanadium, niobium, tantalum, chromium, manganese, iron, cobalt, zinc, aluminum, gallium or indium, X¹ and X² are independently an anionic ligand, J¹ and J² are independently a neutral coordinated ligand bonded to M¹, M² or X, L is a divalent hydrocarbyl or substituted hydrocarbyl tether; n is 0, 1, 2 or 3, m is 0, 1, 2 or 3, and n+m is 1, 2, 3 or 4. The catalyst compound wherein independently any two X¹ may be joined together and any two X² may be joined together to each form a dianionic bidentate group, independently any two J¹ may be joined together and any two J² may be joined together to each form a neutral bidentate group, and independently any X¹ and J¹ may be joined together and any two X² and J² may be joined together to each form a monoanionic bidentate group. R^{w} may include hydrogen, a C₁-C₂₀ hydrocarbyl, a C₁-C₂₀ substituted hydrocarbyl, a halogen, a heteroatom, a heteroatom-containing group, or a combination thereof, wherein w is 1-7, 1′-7′, 1″-7″, or 1″′-7″′.

In one embodiment a catalyst system comprising a catalyst compound, an activator and optionally a support material.

In one embodiment, a method of polymerizing olefins to produce a polyolefin comprising contacting ethylene and optionally at least one or more C₃-C₂₀ olefins with a catalyst system.

These and other features and attributes of the present disclosure and their advantageous applications and/or uses will be apparent from the detailed description which follows.

### BRIEF DESCRIPTION OF THE FIGURES

FIGS. 1A-C, Table 2 shows properties of polymerization samples produced by monometallic and dinuclear catalysts.

FIGS. 2A-2D, Table 3 shows properties of polymerization samples produced by monometallic and dinuclear catalysts.

FIGS. 3A-3D, Table 4 shows properties of polymerization samples produced by monometallic and dinuclear catalysts.

FIGS. 4A-4D, Table 5 shows properties of polymerization samples produced by monometallic and dinuclear catalysts.

FIG. 5, Table 6 shows ethylene/hexene polymerization using supported catalyst systems.

FIG. 6. Table 7 shows GPC results for ethylene/hexene polymerization results.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. All numerical values within the detailed description herein are modified by “about” the indicated value, and take into account experimental error and variations that would be expected by a person having ordinary skill in the art. For example, “about” or “approximately” may refer to ±0.2%, ±0.5%, ±1%, ±2, +5%, ±10%, or ±15%.

For purposes herein a “polymer” has two or more of the same or different monomer (“mer”) units. A “homopolymer” is a polymer having mer units that are the same. A “copolymer” is a polymer having two or more mer units that are different from each other. A “terpolymer” is a polymer having three mer units that are different from each other. “Different” in reference to mer units indicates that the mer units differ from each other by at least one atom or are different isomerically. Accordingly, copolymer, as used herein, can include terpolymers and the like. An “ethylene polymer” or “ethylene copolymer” is a polymer or copolymer comprising at least 50 mole % ethylene derived units, a “propylene polymer” or “propylene copolymer” is a polymer or copolymer comprising at least 50 mole % propylene derived units, and so on.

As used herein, “olefin,” alternatively referred to as “alkene,” is a linear, branched, or cyclic compound of carbon and hydrogen having at least one double bond. For purposes of this specification, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer.

As used herein, “catalyst productivity” is a measure of the mass of polymer produced using a known quantity of supported or unsupported polymerization catalyst per unit time. Unless otherwise noted, “catalyst productivity” is expressed in units of (g of polymer)/(g of supported or unsupported catalyst)/hour. If units are not specified then the “catalyst productivity” is in units of (g of polymer)/(grams of supported or unsupported catalyst)/hour.

As used herein, “conversion” is the percentage of a monomer that is converted to polymer product in a polymerization, and is reported as % and is calculated based on the polymer yield, the polymer composition, and the amount of monomer fed into the reactor.

For purposes of this disclosure, the term “Cₙ” means hydrocarbon(s) having n carbon atom(s) per molecule, wherein n is a positive integer. The term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n. Likewise, a “Cₘ-C_{y}” group or compound refers to a group or compound comprising carbon atoms at a total number thereof in the range from m to y. Thus, a C₁-C₅₀ alkyl group refers to an alkyl group comprising carbon atoms at a total number thereof in the range from 1 to 50. The terms “group,” “radical,” and “substituent” may be used interchangeably.

Unless otherwise indicated, (e.g., the definition of “substituted hydrocarbyl”, etc.), the term “substituted” means that at least one hydrogen atom has been replaced with at least one non-hydrogen group, such as a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)_{q}—SiR*₃, and the like, where q is 1 to 10 and each R* is independently hydrogen, a hydrocarbyl or halocarbyl, and two or more R* may join together to form a substituted or unsubstituted completely saturated, partially unsaturated, or aromatic cyclic or polycyclic ring structure, or where at least one heteroatom has been inserted within a hydrocarbyl ring.

The term “substituted hydrocarbyl” means a hydrocarbyl group in which at least one hydrogen atom of the hydrocarbyl group has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)_{q}—SiR*₃, and the like, where q is 1 to 10 and each R* is independently hydrogen, a hydrocarbyl or halocarbyl, and two or more R* may join together to form a substituted or unsubstituted completely saturated, partially unsaturated, or aromatic cyclic or polycyclic ring structure), or where at least one heteroatom has been inserted within a hydrocarbyl ring.

A heterocyclic ring, also referred to as a heterocyclic, is a ring having a heteroatom in the ring structure as opposed to a “heteroatom-substituted ring” where a hydrogen on a ring atom is replaced with a heteroatom. For example, tetrahydrofuran is a heterocyclic ring and 4-N,N-dimethylamino-phenyl is a heteroatom substituted ring. A substituted heterocyclic ring means a heterocyclic ring having 1 or more hydrogen groups replaced by a hydrocarbyl, substituted hydrocarbyl, heteroatom or heteroatom containing group.

A substituted hydrocarbyl ring means a ring comprised of carbon and hydrogen atoms having 1 or more hydrogen groups replaced by a hydrocarbyl, substituted hydrocarbyl, heteroatom or heteroatom containing group.

A “catalyst system” is a combination of at least one catalyst compound, at least one activator, and an optional support material. When “catalyst system” is used to describe such a pair before activation, it means the unactivated catalyst complex (e.g., precatalyst) together with an activator and, optionally, a co-activator. When it is used to describe such a pair after activation, it means the activated complex and the activator or other charge-balancing moiety. The transition metal compound may be neutral as in a precatalyst, or a charged species with a counter ion as in an activated catalyst system. For the purposes of this invention and the claims thereto, when catalyst systems are described as comprising neutral stable forms of the components, it is well understood by one of ordinary skill in the art, that the ionic form of the component is the form that reacts with the monomers to produce polymers. A polymerization catalyst system is a catalyst system that can polymerize monomers to polymer.

In the description herein, the catalyst may be described as a catalyst, a catalyst precursor, a pre-catalyst compound, catalyst compound or a transition metal compound, and these terms are used interchangeably.

An “anionic ligand” is a negatively charged ligand which donates one or more pairs of electrons to a metal ion. The term “anionic donor” is used interchangeably with “anionic ligand”. Examples of anionic donors in the context of the present invention include, but are not limited to, methyl, chloride, fluoride, alkoxide, aryloxide, alkyl, alkenyl, thiolate, carboxylate, amido, methyl, benzyl, hydrido, amidinate, amidate, and phenyl. Two anionic donors may be joined to form a dianionic group.

A “neutral Lewis base or “neutral donor group” or “neutral ligand” is an uncharged (i.e. neutral) group which donates one or more pairs of electrons to a metal ion. Non-limiting examples of neutral Lewis bases include ethers, thioethers, amines, imines, phosphines, ethyl ether, tetrahydrofuran, dimethylsulfide, triethylamine, pyridine, alkenes, alkynes, alenes, and carbenes. Lewis bases may be joined together to form bidentate or tridentate Lewis bases.

All ranges expressed herein should include both end points as two specific embodiments unless specified or indicated to the contrary.

Production of versatile feedstocks to produce industrial goods to meet the world's growing demand is dependent on olefin polymerization efficiency, yield, and overall performance. One technique for controlling olefin polymerization is by adjusting the performance, productivity, and activity of catalysts used during the polymerization procedure. As such, development of catalysts to increase efficiency, yield, and other reaction parameters is needed.

Accordingly, the present disclosure is directed to compositions of catalyst systems and techniques for generating one or more catalyst systems to improve catalyst activity. Additionally, and/or alternatively, the one or more catalyst systems described herein may improve molecular weight distributions of polymers generated using said catalysts systems. The catalyst systems described herein may include one or more dinuclear tethered catalysts for olefin polymerization. The dinuclear tethered catalysts include a first metal complex having a first metal M¹ and a second metal complex having a second metal M². One or more ligands of the first metal complex are coupled to a tether that is a rigid carbocyclic or heterocyclic backbone, which is also coupled to one or more ligands of the second metal complex, thereby forming the “dinuclear tethered catalyst”. As discussed herein, the tether may include (e.g., comprise, consist of) one or more substituted aromatic cyclic hydrocarbyl moieties, one or more substituted antiaromatic cyclic hydrocarbyl moieties, one or more substituted non-aromatic cyclic hydrocarbyl moieties to form a bis(diiminopyridine) ligand that is complexed with an s-, p- or d-block element to form the precatalyst. The tether may be substantially rigid in that the bonds coupling the ligands to the tether has sp² hybridization. Herein “substantially rigid” is defined as carbocyclic or heterocyclic structures joining two sp² hybridized carbons which are each bound via a single bond to a diiminopyridine ligand thus providing restricted rotation of the tether. It is presently recognized that utilizing such catalysts may provide one or more advantages including increased molecular weight distributions, improved catalyst activity, as discussed in further detail herein.

Additionally, the disclosed techniques provide catalyst compounds or catalyst systems that may be used in solution processes to prepare propylene polymers. The catalyst systems may include an activator, and one or more catalyst compounds as described herein. In some embodiments, the dinuclear tethered catalysts may be supported during gas phase polymerization and/or unsupported during solution phase polymerization. Additionally, and/or alternatively, the catalyst systems described herein may include one or more supported monometallic catalysts. In some embodiments, a catalyst system may include a co-supported system including a dinuclear catalyst and one or more additional catalyst (e.g., a monometallic catalyst, a metallocene catalyst, a post-metallocene catalyst, or a constrained geometry catalyst). For example, the co-supported system may include the dinuclear tethered catalyst and a zirconium metallocene or a post-metallocene catalyst. In any case, disclosed techniques may include contacting propylene with the catalyst compounds or catalyst systems described herein. In certain embodiments, the disclosed techniques may include copolymerizing propylene and at least one C₄-C₂₀ alpha olefin using the catalyst compounds described herein comprising contacting propylene and at least one C₄-C₂₀ alpha olefin with a catalyst system comprising an activator and a catalyst compound described herein.

As one non-limiting example, the catalyst systems may include two diimino pyridine ligands tethered together using a rigid carbocylic or heterocycle backbone to form a bis(diiminopyridine) ligand. The bis(diiminopyridine) ligand may be complexed with a s-block, a p-block, or a d-block element to form a precatalyst. The precatalyst may be activated for use in a solution reactor or supported by an activator for use in a gas-phase reactor and/or slurry reactor. The activated catalyst may be used to polymerize olefins.

### Catalyst Compounds and Systems

As described above, the catalyst compound or catalyst systems may include two metal complexes (e.g., a first metal complex and a second metal complex) with ligands coupled to a tether. Examples of the catalyst compounds or catalysts systems are described in detail below. In some embodiments, the catalyst compound may be represented by Formula (I).

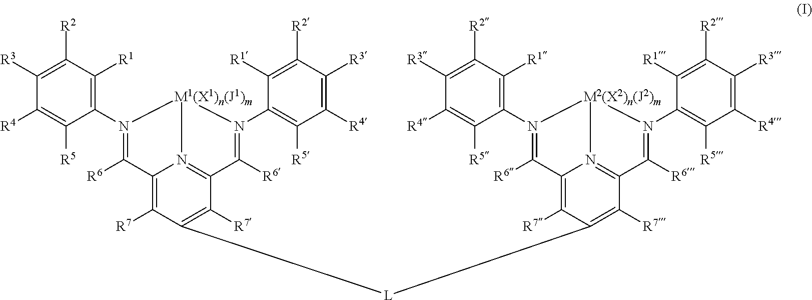

In certain embodiments, M¹ and M² may be independently selected from magnesium, vanadium, niobium, tantalum, chromium, manganese, iron, cobalt, zinc, aluminum, gallium, indium, or a combination thereof. Preferably, M¹ and M² are independently selected from iron, vanadium or cobalt. More preferably, M¹ and M² are selected from iron or vanadium. X¹ may include one or more anionic ligands. X² may include one or more additional anionic ligands. In some instances, X¹ and/or X² includes a halogen. J¹ and J² may include independently a neutral coordinated ligand bonded to M¹, M², X, or a combination thereof. In some embodiments, L (e.g., a tether) is a divalent hydrocarbyl or substituted hydrocarbyl tether. As disclosed herein, n is 0, 1, 2 or 3, m is 0, 1, 2 or 3, and n+m is 1, 2, 3 or 4.

In some embodiments, each of R^{w} (e.g., R¹, R², R³, R⁴, R⁵, R^{1′}, R^{2′}, R^{3′}, R^{4′}, R^{5′}, R^{1″}, R^{2″}, R^{3″}, R^{4″}, R^{5″}, R^{1′″}, R^{2′″}, R^{3′″}, R^{4′″} and R^{5′″}, and so on) may include hydrogen, a C₁-C₂₀ hydrocarbyl, a C₁-C₂₀ substituted hydrocarbyl, a halogen, a heteroatom, a heteroatom-containing group, or a combination thereof. R¹, R², R³, R⁴, R⁵, R^{1′}, R^{2′}, R^{3′}, R^{4′}, R^{5′} R^{1″}, R^{2″}, R^{3″}, R^{4″}, R^{5″}, R^{1′″}, R^{2′″}, R^{3′″}, R^{4′″} and R^{5′″}, is preferably a hydrogen, a C₁-C₂₀ hydrocarbyl, or a C₁-C₂₀ substituted hydrocarbyl. In certain embodiments, one or more of R¹ and R², R^{1′} and R^{2′}, R^{1″} and R^{2″}, R^{1′″} and R^{2′″}, R² and R³, R^{2′} and R^{3′}, R^{2″} and R^{3″}, R^{2′″} and R^{3′″}, R³ and R⁴, R^{3′} and R^{4′}, R^{3″} and R^{4″}, R^{3′″} and R^{4′″}, R⁴ and R⁵, R^{4′} and R^{5′}, R^{4″} and R^{5″}, R^{4′″} and R^{5′″} may be joined to form one or more substituted hydrocarbyl rings, unsubstituted hydrocarbyl rings, substituted heterocyclic rings, or unsubstituted heterocyclic rings. Each of the heterocyclic rings may have 5, 6, 7, or 8 ring atoms. In certain embodiments, R⁶, R⁷, R^{6′}, R^{7′}, R^{6″}, R^{7″}, R^{6′″}, R^{7′″} may independently comprise hydrogen, a C₁-C₂₀ hydrocarbyl, a C₁-C₂₀ substituted hydrocarbyl, a heteroatom or a heteroatom-containing group, or a combination thereof. In some instances, one or more of R⁶ and R⁷, R^{6′} and R^{7′}, R^{6″} and R^{7″}, R^{6′″} and R^{7′″} may be joined to form one or more substituted hydrocarbyl rings, unsubstituted hydrocarbyl rings, substituted heterocyclic rings, or unsubstituted heterocyclic rings each having 5, 6, 7, or 8 ring atoms.

In certain embodiments, any two X¹ may be joined together and any two X² may be joined together to each form a dianionic bidentate group. Further, any two J¹ may be joined together and any two J² may be joined together to each form a neutral bidentate group. In some instances, any X¹ and any J¹ may be joined together and any two X² and any J² may be joined together to each form a monoanionic bidentate group. In some embodiments, X¹, X², or a combination thereof may include a halogen or a C₁-C₂₀ hydrocarbyl. The C₁-C₂₀ hydrocarbyl may comprise one or more heteroatoms. In some instances, J¹ and J² may include a C₁-C₂₀ hydrocarbyl group. The C₁-C₂₀ hydrocarbyl group may include one or more heteroatoms, a heteroatom containing group, or a combination thereof.

In some embodiments, the tether of the catalyst compound may include one or more substituted aromatic cyclic hydrocarbyl moieties, one or more substituted antiaromatic cyclic hydrocarbyl moieties, one or more substituted non-aromatic cyclic hydrocarbyl moieties, and the like. It should be noted that the tether may provide structural rigidity to the catalyst compound of Formula (I). A metal-to-metal distance of M¹ and M² may control an extent of rigidity of the catalyst compound of Formula (I). For example, in instances in which M¹ and M² are proximal to one another (e.g., within a metal-to-metal distance of about 16 Å) the extent of rigidity of the catalyst compound may increase. Without wishing to be bound by theory, the tether may increase electronic transfer, separation of the M¹ and M², and the like to promote catalyst activity.

In certain embodiments, the tether may be selected from compounds represented by Formula II-Formula X below.

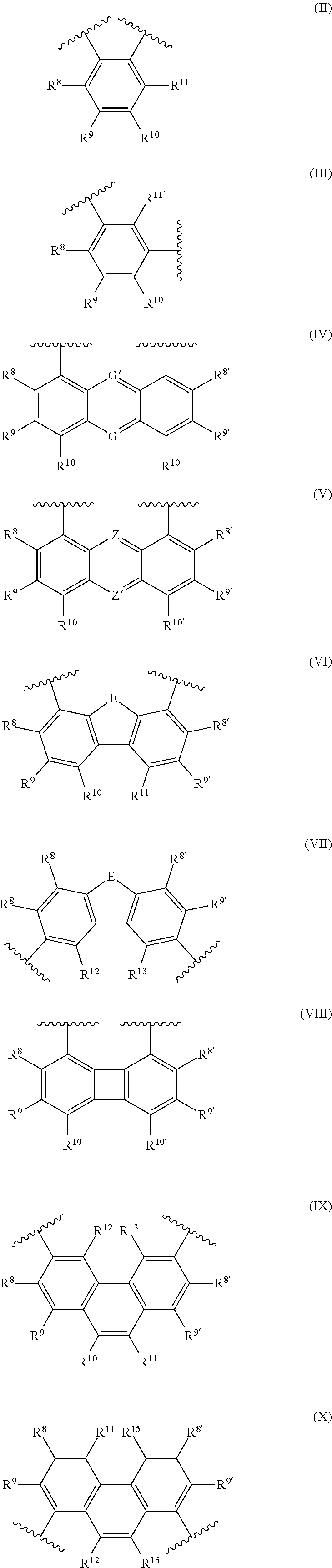

It should be noted, that [symbol] denotes the positions per molecule which are substituted with a tridentate diimino pyridine ligand through a C—C single bond with each ligand being bound to a metal. In some embodiments, E may include BR, CR₂, SiR₂, NR, PR, PR₃, SbR, SbR₃, O, S, Se, Te, or a combination thereof. Z may include BR, CR₂, SiR₂, NR, PR, PR₃, SbR, SbR₃, O, S, Se, Te, or a combination thereof. Z′ may include BR, CR₂, SiR₂, NR, PR, PR₃, SbR, SbR₃, O, S, Se, Te, or a combination thereof.

In certain embodiments, G and G′ may be C—R or N. In some instances, R is hydrogen, C₁-C₂₀ hydrocarbyl, a C₁-C₂₀ substituted hydrocarbyl, a heteroatom, a heteroatom containing group, or a combination thereof. R⁸, R^{8′} R⁹, R^{9′}, R¹⁰, R^{10′}, R¹¹, R^{11′}, R¹², R¹³, R¹⁴, and R¹⁵ may include hydrogen, a C₁-C₂₀ hydrocarbyl, a C₁-C₂₀ substituted hydrocarbyl, a halogen, a heteroatom, a heteroatom-containing group, or a combination thereof. In some embodiments, one or more of R⁸ and R⁹, R^{8′} and R^{9′}, R⁹ and R¹⁰, R^{9′} and R^{10′}, R¹⁰ and R¹¹, R¹² and R¹³, R⁸ and R¹⁴, R^{8′} and R¹⁵, R^{9′} and R¹¹, R¹⁴ and R¹⁵ may be joined to form one or more substituted hydrocarbyl rings, unsubstituted hydrocarbyl rings, substituted heterocyclic rings, or unsubstituted heterocyclic rings. The heterocyclic rings may each include 5, 6, 7, or 8 ring atoms.

In some embodiments, Z and Z′ atoms of the tethers may be independently selected from BR, CR₂, SiR₂, NR, PR, SbR. In some instances, an R-group of Z is joined with an R-group of Z′ to form one or more substituted hydrocarbyl rings or one or more unsubstituted hydrocarbyl rings. It should be noted, that the hydrocarbyl rings may include one or more heteroatoms. Additionally, and/or alternatively, the one or more substituted hydrocarbyl rings and/or the one or more unsubstituted hydrocarbyl rings may include 5, 6, 7, or 8 ring atoms.

In some embodiments, the catalyst system may include a monometallic catalyst compound. The monometallic catalyst compound may be represented by Formula (XI).

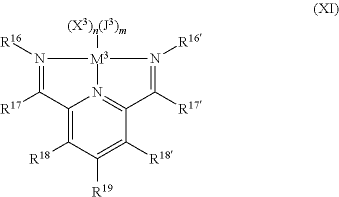

In certain embodiments, M³ may be selected from magnesium, vanadium, niobium, tantalum, chromium, manganese, iron, cobalt, zinc, aluminum, gallium or indium. Preferably, M³ may be iron, vanadium or cobalt. More preferably, M³ may be iron or vanadium. R¹⁶ and R^{16′} may include a substituted hydrocarbyl, a heteroatom or a heteroatom-containing group, one or more substituted hydrocarbyl rings, unsubstituted hydrocarbyl rings, substituted heterocyclic rings, or unsubstituted heterocyclic rings each having 5, 6, 7, or 8 ring atoms, or a combination thereof. R¹⁷, R^{17′}, R¹⁸, R^{18′} and R¹⁹ may include a substituted hydrocarbyl, a heteroatom or a heteroatom-containing group, or a combination thereof. R¹⁷ and R¹⁸, R^{17′} and R^{18′}, R¹⁸ and R¹⁹, R^{18′} and R¹⁹ may be joined to form one or more substituted hydrocarbyl rings, unsubstituted hydrocarbyl rings, substituted heterocyclic rings, or unsubstituted heterocyclic rings. The heterocyclic rings may each include 5, 6, 7, or 8 ring atoms. X³ may include one or more anionic ligands, one or more substituted hydrocarbyls, and/or one or more halogens. J³ may include a C₁-C₂₀ hydrocarbyl group. The C₁-C₂₀ hydrocarbyl group may include one or more heteroatoms, a heteroatom containing group, or a combination thereof. As disclosed herein, n may be 0, 1, 2 or 3 and m is 0, 1, 2 or 3 and n+m=1, 2, 3 or 4. X³ and J³ may be joined together to form a monoanionic bidentate group.

Olefin polymerization may be performed in a gas phase reactor, a slurry phase reactor, a solution phase reactor, and the like. As such, the catalyst system may include a catalyst compound (e.g., Formula (I), Formula (XI)) a support material, an activator, or a combination thereof. In some embodiments, the catalyst system comprises a dinuclear tethered catalyst and a second catalyst selected from a metallocene, post-metallocene, constrained-geometry catalyst, and the like. In some embodiments, the activator may include an alkylaluminum selected from the group methylalumoxane (MAO), modified methylalumoxane (MMAO), ethylalumoxane, solid polymethylaluminoxane (sMAO), isobutylalumoxane, diethylaluminum chloride, ethylaluminum sesquichloride, dimethyl aluminum chloride, ionic methylalumoxane (i-MAO) fluorinated methylalumoxane (F-MAO), solid ionic methylalumoxane (sMAO-i), solid fluorinated methylalumoxane (sMAO-f), solid heated fluorinated methylalumoxane (sMAO-hf), or a combination thereof. In some embodiments, the alkylaluminum may be present at a molar ratio of aluminum to the catalyst compound of 50:1 or more. For example, the molar ratio of aluminum to the catalyst compound may be about 50:1, about 90:1, about 100:1, about 150:1, about 200:1, about 350:1, about 500:1, about 650:1, and the like. In certain embodiments, the support may include Al₂O₃, ZrO₂, SiO₂, SiO₂/Al₂O₃, SiO₂/TiO₂, silica clay, silicon oxide/clay, or mixtures thereof. Other inorganic oxides that may be employed either alone or in combination as the support such as magnesia, titania, zirconia, and the like. Other suitable support materials may include finely divided functionalized polyolefins, such as finely divided polyethylene, magnesia, titania, zirconia, montmorillonite, phyllosilicate, zeolites, talc, clays, and the like. The support may also comprise a solid oxide optionally treated with an electron-withdrawing anion. The solid oxide may be selected from the group consisting of silica, alumina, silica-alumina, silica-zirconia, alumina-zirconia, aluminum phosphate, heteropolytungstates, titania, magnesia, boria, zinc oxide, mixed oxides thereof, and mixture(s) thereof, and the electron-withdrawing anion is selected from the group consisting of fluoride, chloride, bromide, phosphate, triflate, bisulfate, sulfate, and combination(s) thereof. The support may a surface area in the range of from about 10 to about 700 m²/g, pore volume in the range of from about 0.1 to about 4.0 cc/g and average particle size in the range of from about 5 to about 500 μm. It should be noted, that a “supported catalyst” as described herein may include a catalyst compound, an activator, and a support. That is, the activator may be embedded within the support used to support the catalyst compound.

### Methods to Prepare the Catalyst Compounds and Systems

Example techniques for preparing the catalyst compounds or catalysts systems are described in detail below. It should be noted, unless otherwise indicated, all reactions and manipulations were carried out under an atmosphere of dry, O₂-free nitrogen using standard double-manifold techniques with a rotary oil pump or a nitrogen-filled glove box. Solvents, including deuterated NMR solvents, were degassed by sparging with nitrogen gas, dried over activated 3 Å molecular sieves and stored under a nitrogen atmosphere. ¹H NMR spectra were recorded on a Bruker Avance Neo 400 spectrometer. Chemical shifts are expressed as parts per million (ppm, δ) downfield of tetramethylsilane (TMS) and are referenced to CDCl₃ (7.26 ppm) or CD₂Cl₂ (5.32 ppm). The description of signals include: s=singlet, d=doublet, t=triplet, m=multiplet and br.=broad. Coupling constants are absolute values and are expressed in Hertz (Hz). Further, as described herein, unless otherwise noted, yields are given as isolated yields. Chemicals were purchased from commercial suppliers and used as received; 2,6-diacetylpyridine, (Ambeed, Sigma-Aldrich), 2,4,6-trimethylaniline (Sigma-Aldrich), 2,6-dimethylaniline (Sigma-Aldrich), ethanol (EtOH) (Fisher Scientific), formic acid (Sigma-Aldrich), methanol (MeOH) (Fisher Scientific), dichloromethane (Fisher Scientific), cis-cyclooctene (cis-COE) (Fisher Scientific), pinacolborane (HBPin) (Sigma-Aldrich), (1,5-cyclooctadiene)(methoxy) iridium (I) dimer ([Ir(COD)(OMe)]₂) (Strem), 4,4′-di-tert-butyl-2,2′-dipyridyl (Sigma-Aldrich), bis(pinacolato)diboron (B₂Pin₂) (Sigma-Aldrich), 4,5-dibromo-2,7-ditert-butyl-9,9-dimethyl-xanthene (Sigma-Aldrich), potassium fluoride (Sigma-Aldrich), tris(dibenzylideneacetone) dipalladium (Pd₂dba₃) (Sigma-Aldrich), potassium phosphate (Sigma-Aldrich), dicyclohexyl [2′,4′,6′-tris(propan-2-yl) [1,1′-biphenyl]-2-yl]phosphane (XPhos) (Sigma-Aldrich), 1,4-dioxane (Sigma-Aldrich), magnesium sulfate (MgSO₄) (Sigma-Aldrich), diethyl ether (Et₂O) (Sigma-Aldrich), pentane (Fisher Scientific), hexane (Fisher Scientific), p-toluene sulfonic acid (pTsOH) (Sigma-Aldrich), toluene (Sigma-Aldrich), d-chloroform (CDCl₃) (Cambridge Isotope Laboratory), iron dichloride (FeCl₂) (Strem), d₂-dichloromethane (CD₂Cl₂) (Cambridge Isotope Laboratory), tetrahydrofuran (THF) (Sigma-Aldrich), iron trichloride (FeCl₃) (Strem), vanadium trichloride (VCl₃) (Sigma-Aldrich), cobalt dichloride (CoCl₂) (Sigma-Aldrich), zinc dichloride (ZnCl₂) (Alfa Aesar), methylaluminoxane (MAO) (W. R. Grace) (THF) 3 VCl₃ was synthesized according to literature protocols (Inorg. Synth., 1982, 21, 135-140.).

### Ligand Synthesis

As described above, the catalyst compound or catalyst systems may include two metal complexes (e.g., a first metal complex and a second metal complex) with ligands coupled to a tether. Examples of the ligands of the catalyst compounds or catalysts systems are described in detail below. The ligands may be pyridine diamine ligands. Example methods for producing, generating, or synthesizing the ligands of the disclosed dinuclear tethered catalysts and/or catalyst systems are described below.

Diimino pyridine ligands may be prepared using the general methods described herein. The diimino pyridine ligands may include compounds PL1, PL2, PL3, PL4, PL5, PL6, PL7, PL8, PL9, PL10, PL11, PL12, PL13, PL14, and/or one or more additional diimino pyridine ligand. In some embodiments, synthesis of the diimino pyridine ligands (e.g., compound PL2, compound PL5) may be generated through functionalization by diboron (4) and/or dioxaborolane. In certain embodiments, the diimino pyridine ligands (e.g., compound PL3, PL6, PL7, and PL8) may be prepared by known Pd- and Ni-catalyzed couplings, such as Negishi, Suzuki, or Kumada couplings.

Compound PL1 is represented by Formula (PL1). As shown by Formula (PL1), compound PL1, is (1E,1′E)-1,1′-(pyridine-2,6-diyl)bis(N-mesitylethan-1-imine).

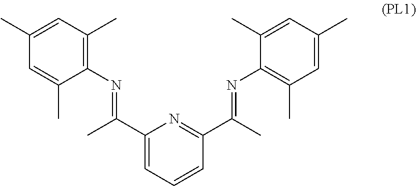

Compound PL1 is synthesized following a procedure adapted from the literature (Dalton Trans., 2013, 42, 13723-13732). (2,6-Diacetylpyridine (4.00 g, 24.5 mmol, 1 equiv.) and 2,4,6-trimethylaniline (6.89 g, 51.0 mmol, 2.08 equiv.) were added to a flask containing ethanol (150 mL) and formic acid (0.8 mL, 0.02 mmol, 0.08 mol %) to form a reaction mixture. The reaction mixture was stirred for 48 hours at ambient temperature. A portion of ethanol was evaporated from the reaction mixture to produce yellow crystals. The yellow crystals were isolated and washed with cold methanol and dried under vacuum at 40° C. Subsequent recrystallizations from CH₂Cl₂ and MeOH at −40° C. were performed to produce more crops of the compound PL1. The yield of the synthesis of compound PL1 is 6.32 g, 15.9 mmol, 65%. Compound PL1 characterized by ¹H NMR (400 MHz, CDCl₃) includes δ/ppm: 8.47 (2H, d, ³J_{HH}=7.82 Hz, Pyr-H), 7.91 (1H, t, ³J_{HH}=7.82 Hz, Pyr-H), 6.91 (4H, s, Ar—H), 2.31 (6H, s, imine-Me), 2.24 (6H, s, Ar—Me), 2.03 (12H, s, Ar—Me).

Compound PL2 is represented by Formula (PL2). As shown by Formula (PL2), compound PL2, is (1E,1′E)-1,1′-(4-(4,4,5,5-tetramethyl-1,3,2-dioxaborolan-2-yl)pyridine-2,6-diyl)bis(N-mesitylethan-1-imine).

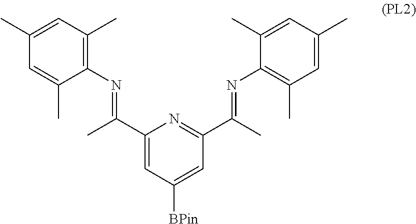

Compound PL2 is synthesized by mixing a solution of Cis-COE (55 mg, 0.5 mmol, 5 mol %) with HBPin (64 mg, 0.5 mmol, 5 mol %) in isohexane (2 mL) to form a reaction mixture. A solution of [Ir(COD)(OMe)]₂ (33 mg, 0.05 mmol, 0.5 mol %) in isohexane (2 mL) was added to the reaction mixture. The reaction mixture was added to 4,4′-Di-tert-butyl-2,2′-dipyridyl (17 mg, 0.06 mmol, 0.6 mol %) as a solution in isohexane (2 mL) to produce a red catalyst solution (e.g., dark red solution) when left to stir for 5 minutes. Separately, a mixture of Compound PL1 (5.00 g, 12.6 mmol, 1 equiv.) and B₂Pin₂ (3.26 g, 12.8 mmol, 1.02 equiv.) were suspended in isohexane (100 mL) and set to stir under ambient temperatures. The red catalyst solution was then added to the mixture giving an orange cloudy mixture which was left to stir at 60° C. for 18 hours. The mixture was cooled to ambient temperature then filtered over a frit with the filtride being isolated and washed with hexane until the washings were clear and dried under vacuum to yield the product as a pale yellow solid (e.g., compound PL2). The yield of the compound PL2 is 6.12 g, 11.69 mmol, 93%. The compound PL2 as characterized by ¹H NMR (400 MHz, CDCl₃) including δ/ppm: 8.77 (2H, s, Pyr-H), 6.89 (4H, s, Ar—H), 2.30 (6H, s, imine-H), 2.23 (6H, s, Ar—Me), 2.03 (12H, s, Ar—Me), 1.37 (12H, s, BPin).

Compound PL3 is represented by Formula (PL3). As shown by Formula (PL3), compound PL3, is (1E,1′E,1″E,1′″E)-1,1′,1″,1′″-((2,7-di-tert-butyl-9,9-dimethyl-9H-xanthene-4,5-diyl)bis(pyridine-4,2,6-triyl))tetrakis(N-mesitylethan-1-imine).

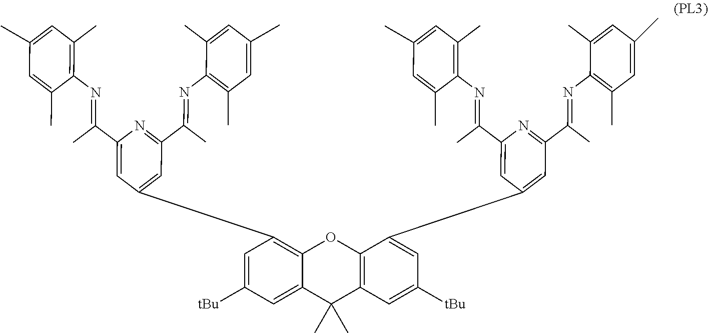

Compound PL3 is synthesized by combining PL2 (750 mg, 1.4 mmol, 1 equiv.), 4,5-dibromo-2,7-ditert-butyl-9,9-dimethyl-xanthene (344 mg, 0.72 mmol, 0.5 equiv.), potassium fluoride (117 mg, 2.02 mmol, 1.41 equiv.), Pd₂dba₃ (6 mg, 6.73 μmol, 0.5 mol %), potassium phosphate (870 mg, 4.1 mmol, 2.86 equiv.), XPhos (3 mg, 6.73 μmol, 0.5 mol %) in a scintillation vial with degassed dioxane (10 mL)/water (2 mL) mixture being added. The scintillation vial was sealed tightly and heated to 100° C. for 18 hours. The scintillation vial was removed from the heat and left to cool to ambient temperature. Contents of the cooled scintillation vial were then washed with water, then extracted with CH₂Cl₂ (3×7 mL) with the combined organic extracts being washed with brine. The organic fraction was partitioned and filtered through celite to remove any residual solids then dried over MgSO₄. Volatiles were removed via rotovap leaving a tacky yellow solid. The tacky yellow solid was then washed with minimal ether (2×3 mL) and pentane (2×5 mL). The washed tacky yellow solid was then dried under high vacuum producing PL3 as a pale yellow solid. The yield of the compound PL3 is 674 mg, 0.61 mmol, 84%. The compound PL3 as characterized by ¹H NMR (400 MHz, CDCl₃) includes δ/ppm: 8.31 (4H, s, Pyr-H), 7.53 (2H, d, 4JHH=2.35 Hz, Xan-H), 7.28 (2H, d, 4JHH=2.33 Hz, Xan-H), 6.83 (8H, s, Ar—H), 2.28 (12H, s, imine-Me), 2.03 (12H, s, Ar—Me), 1.90 (24H, s, Ar—Me), 1.79 (6H, s, Xan-Me), 1.36 (18H, s, Xan-tBu).

Compound PL4 is represented by Formula (PL4). As shown by Formula (PL4), compound PL4, is (1E,1′E)-1,1′-(pyridine-2,6-diyl)bis(N-(2,6-dimethylphenyl) ethan-1-imine).

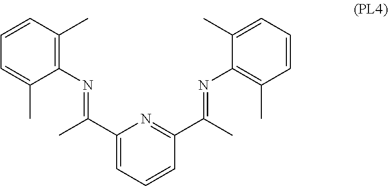 [SMILES: C/C(=N\c1c(C)cccc1C)c1cccc(/C(C)=N/c2c(C)cccc2C)n1]

Compound PL4 is synthesized by combining 2,6-diacetylpyridine (10.0 g, 61.3 mmol, 1 equiv.)) and pTsOH (0.4 g, 2.1 mmol, 3.4 mol %) and 2,6-dimethylaniline (26.0 g, 214 mmol, 3.5 equiv.) in toluene, and set to reflux with dean Stark apparatus for 3 hours. After 3 hours, the toluene was removed with the residue being slurried into hot methanol (100 mL), then cooled to ambient temperature. The cooled combination was then placed in the freezer for 1 hour. The compound PL4 is isolated by filtration which was subsequently washed with hexane to yield the compound PL4 as a yellow solid. The yield of the compound PL4 is 21.4 g, 57.9 mmol, 95%. The compound PL4 as characterized by ¹H NMR (400 MHz, CDCl₃) includes δ/ppm: 8.51 (2H, d, ³J_{HH}=7.54 Hz, Pyr-H), 7.93 (1H, t, ³J_{HH}=7.82 Hz, Pyr-H), 7.10 (4H, d, ³J_{HH}=7.47 Hz, Ar—H), 6.96 (2H, t, ³J_{HH}=7.60 Hz, Ar—H), 2.26 (6H, s, imine-Me), 2.07 (12H, s, Ar—Me).

Compound PL5 is represented by Formula (PL5). As shown by Formula (PL5), compound PL5, is (1E,1′E)-1,1′-(4-(4,4,5,5-tetramethyl-1,3,2-dioxaborolan-2-yl)pyridine-2,6-diyl)bis(N-(2,6-dimethylphenyl) ethan-1-imine).

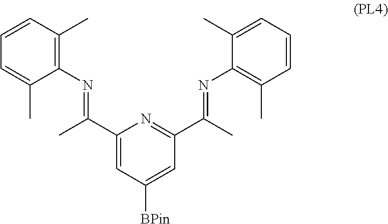

Compound PL5 is synthesized by producing a solution of Cis-COE (44 mg, 0.4 mmol, 4 mol %) with HBPin (51 mg, 0.4 mmol, 4 mol %) in isohexane (2 mL). The solution was added to a solution of [Ir(COD)(OMe)]₂ (27 mg, 0.04 mmol, 0.4 mol %) in isohexane (2 mL). To this, 4,4′-Di-tert-butyl-2,2′-dipyridyl (13 mg, 0.05 mmol, 0.5 mol %) was added as a solution in isohexane (2 mL) to give a red catalyst solution (e.g., a dark red solution). The red catalyst solution is stirred for 5 minutes. Separately, a mixture of compound PL4 (3.7 g, 10 mmol, 1 equiv.) and B₂Pin₂ (2.59 g, 10.2 mmol, 1.02 equiv.) were suspended in isohexane (100 mL) and set to stir under ambient temperatures. The red catalyst solution is to the mixture generating an orange cloudy mixture which was left to stir at 60° C. for 18 hours. The reaction was cooled to ambient temperature then filtered over a frit with the filtride being isolated and washed with hexane until the washings were clear and dried under vacuum to yield the compound PL5, as a pale yellow solid. The yield of the compound PL5 is 4.44 g, 8.96 mmol, 90%. The compound PL5 as characterized by ¹H NMR (400 MHz, CDCl₃) includes δ/ppm: 8.80 (2H, s, Pyr-H), 7.08 (4H, d, ³J_{HH}=7.78 Hz, Ar—H), 6.94 (2H, t, ³J_{HH}=7.49 Hz, Ar—H), 2.24 (s, 6H, imine-Me), 2.07 (12H, s, Ar—Me), 1.37 (12H, s, BPin).

Compound PL6 is represented by Formula (PL6). As shown by Formula (PL6), compound PL6, is (1E,1′E,1″E,1′″E)-1,1′,1″,1′″-((2,7-di-tert-butyl-9,9-dimethyl-9H-xanthene-4,5-diyl)bis(pyridine-4,2,6-triyl))tetrakis(N-(2,6-dimethylphenyl) ethan-1-imine).

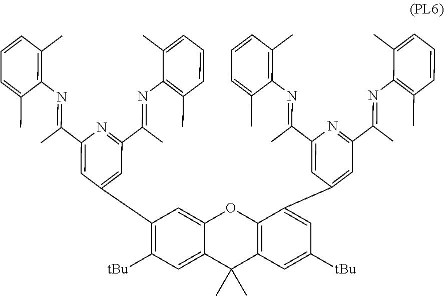 [SMILES: C/C(=N\c1c(C)cccc1C)c1cc(-c2cc3c(cc2C(C)(C)C)C(C)(C)c2cc(C(C)(C)C)cc(-c4cc(/C(C)=N/c5c(C)cccc5C)nc(/C(C)=N/c5c(C)cccc5C)c4)c2O3)cc(/C(C)=N/c2c(C)cccc2C)n1]

Compound PL6 is synthesized by combining compound PL5 (700 mg, 1.4 mmol, 1 equiv.), 4,5-dibromo-2,7-ditert-butyl-9,9-dimethyl-xanthene (339 mg, 0.71 mmol, 0.5 equiv.), potassium fluoride (116 mg, 1.99 mmol, 1.41 equiv.), Pd₂dba₃ (6 mg, 6.64 μmol, 0.5 mol %), potassium phosphate (858 mg, 4.04 mmol, 2.86 equiv.), XPhos (3 mg, 6.64 μmol, 0.5 mol %) in a scintillation vial with degassed dioxane (10 mL)/water (2 mL) mixture being added. The scintillation vial was sealed tightly and heated to 90° C. for 5 hours. The scintillation vial was removed from the heat and let cool to ambient temperature. Contents of the scintillation vial were then washed with water, extracted with CH₂Cl₂ (3×7 mL) with the combined organic extracts being washed with brine. The organic fraction was then filtered through celite to remove any residual solids then dried over MgSO₄. Volatiles were removed via rotovap leaving a tacky yellow solid. The tacky yellow solid was then washed with minimal ether (2×3 mL) and pentane (2×5 mL). The washed tacky yellow solid was then dried under high vacuum to give the compound PL6 as a pale yellow solid. The yield of the compound PL6 is 615 mg, 0.58 mmol, 82%. The compound PL6 as characterized by ¹H NMR (400 MHz, CDCl₃) includes δ/ppm: 8.34 (4H, s, Pyr-H), 7.54 (2H, d ⁴J_{HH}=2.34 Hz, Xan-H), 7.29 (2H, d, ⁴J_{HH}=2.30 Hz, Xan-H), 7.01 (8H, d, ³J_{HH}=7.48 Hz, Ar—H), 6.91 (4H, dd, ³J_{HH}=8.02 Hz, 6.93 Hz, Ar—H), 2.04 (12H, s, imine-Me), 1.94 (24H, s, Ar—Me), 1.80 (6H, S, Xan-Me), 1.37 (18H, s, Xan-′Bu).

Compound PL7 is represented by Formula (PL7). As shown by Formula (PL7), compound PL7, is (1E,1′E,1″E,1′″E)-1,1′,1″,1′″-(1,2-phenylenebis(pyridine-4,2,6-triyl))tetrakis(N-mesitylethan-1-imine).

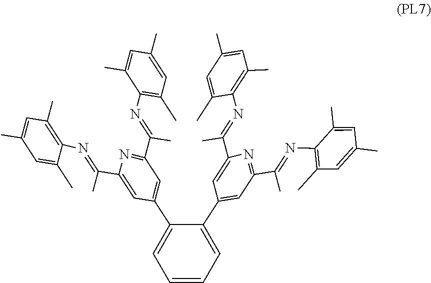

Compound PL7 is synthesized by combining compound PL2 (785 mg, 1.5 mmol, 1 equiv.), 1,2-dibromobenzene (177 mg, 0.75 mmol, 0.5 equiv.), potassium fluoride (123 mg, 2.12 mmol, 1.41 equiv.), Pd₂dba₃ (6.5 mg, 7.05 μmol, 0.5 mol %), potassium phosphate (911 mg, 4.3 mmol, 2.86 equiv.), XPhos (3.4 mg, 7.05 μmol, 0.5 mol %) in a scintillation vial with degassed dioxane (10 mL)/water (2 mL) mixture being added. The scintillation vial is sealed tightly and heated to 100° C. for 18 hours. The scintillation vial is removed from the heat and let cool to ambient temperature. Contents of the scintillation vial is washed with water, extracted with CH₂Cl₂ (3×7 mL) with the combined organic extracts being washed with brine. The organic fraction is filtered through celite to remove any residual solids then dried over MgSO₄. Volatiles are removed via rotovap leaving a tacky yellow solid. The tacky yellow solid is triturated with pentane to give a bright yellow solid with orange supernatant which is removed via filtration. The filtride is washed a further two times until washings ran clear. The filtride is dried under high vacuum to give the compound PL7 as a bright yellow solid. The yield of the compound PL7 is 572 mg, 0.66 mmol, 88%. The compound PL7 as characterized by ¹H NMR (400 MHz, CDCl₃) includes δ/ppm: 8.32 (4H, s, Pyr-H), 7.69 (2H, dd, ³J_{HH}=5.70 Hz, ⁴J_{HH}=3.34 Hz, Ph-H), 7.55 (2H, dd, ³J_{HH}=5.72 Hz, ⁴J_{HH}=3.34 Hz, Ph-H), 6.83 (8H, s, Ar—H), 2.27 (12H, s, imine-Me), 2.14 (12H, s, Ar—Me), 1.83 (24H, s, Ar—Me).

Compound PL8 is represented by Formula (PL8). As shown by Formula (PL8), compound PL8, is (1E,1′E,1″E,1′″E)-1,1′,1″,1′″-(1,2-phenylenebis(pyridine-4,2,6-triyl))tetrakis(N-(2,6-dimethylphenyl) ethan-1-imine).

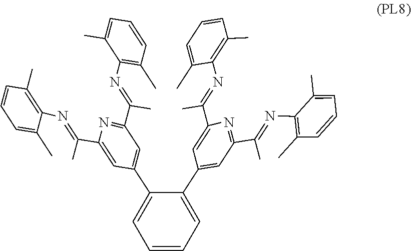 [SMILES: C/C(=N\c1c(C)cccc1C)c1cc(-c2ccccc2-c2cc(/C(C)=N/c3c(C)cccc3C)nc(/C(C)=N/c3c(C)cccc3C)c2)cc(/C(C)=N/c2c(C)cccc2C)n1]

Compound PL8 is synthesized by combining compound PL5 (495 mg, 1.0 mmol, 1 equiv.), 1,2-dibromobenzene (118 mg, 0.50 mmol, 0.5 equiv.), potassium fluoride (82 mg, 1.41 mmol, 1.41 equiv.), Pd₂dba₃ (4 mg, 4.70 μmol, 0.5 mol %), potassium phosphate (607 mg, 2.86 mmol, 2.86 equiv.), XPhos (2 mg, 4.70 μmol, 0.5 mol in a scintillation vial with degassed dioxane (10 mL)/water (2 mL) mixture being added. The scintillation vial is sealed tightly and heated to 100° C. for 18 hours. The scintillation vial is removed from the heat and let cool to ambient temperature. Contents of the scintillation vial is washed with water, extracted with CH₂Cl₂ (3×7 mL) with the combined organic extracts being washed with water. The organic fraction is dried over Na₂SO₄. Volatiles are removed under reduced pressure. Flash chromatography using 1:1 CH₂Cl₂/hexanes gave the product as a beige/yellow solid. The beige/yellow solid is dried under high vacuum to give the compound PL8 as a bright yellow solid. The yield of the compound PL8 is 407 mg, 0.31 mmol, 62%. The compound PL8 as characterized by ¹H NMR (400 MHz, CDCl₃) includes δ/ppm: 8.34 (4H, s, Pyr-H), 7.69 (2H, dd, ³J_{HH}=5.73 Hz, ⁴J_{HH}=3.32 Hz, Ph-H), 7.56 (2H, dd, ³J_{HH}=5.70 Hz, ⁴J_{HH}=3.33 Hz, Ph-H), 7.00 (8H, d, ³J_{HH}=7.51 Hz, Ar—H), 6.89 (4H, dd, ³J_{HH}=8.02 Hz, ³J_{HH}=6.93 Hz, Ar—H), 2.14 (12H, s, imine-Me), 1.86 (24H, s, Ar—Me).

Compound PL9 is represented by Formula (PL9). As shown by Formula (PL9), compound PL9, is 3,6-di-tert-butyl-9-methyl-9H-carbazole.

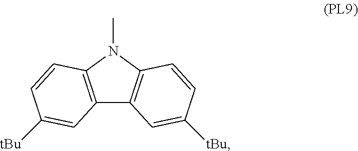 [SMILES: Cn1c2ccc(C(C)(C)C)cc2c2cc(C(C)(C)C)ccc21]

Compound PL9 is synthesized by adding sodium hydride (0.064 g, 2.68 mmol, 1.5 equiv.) slowly to a flask containing 3,6-di-tert-butyl-9H-carbazole (0.50 g, 1.79 mmol, 1 equiv.) in dimethylformamide (45 mL) to form a reaction mixture. The reaction mixture is stirred at ambient temperature for 30 minutes at which point iodomethane (0.381 g, 2.68 mmol, 1.5 equiv.) is added. Stirring is continued at room temperature overnight. The reaction mixture is quenched with water and extracted with dichloromethane (3×20 mL). Combined organics were washed with brine, dried over MgSO₄, filtered and concentrated under vacuum. The yield of compound PL9 is 0.46 g, 1.56 mmol, 88%. The compound PL9 as characterized by ¹H NMR ¹H NMR (400 MHz, CDCl₃) δ/ppm: 8.14 (2H, d, ⁴J_{HH}=1.89 Hz, Ar—H), 7.56 (2H, dd, ³J_{HH}=8.55, ⁴J_{HH}=1.96 Hz, Ar—H), 7.34 (2H, d, ³J_{HH}=8.56 Hz, Ar—H), 3.84 (3H, s, N-Me), 1.50 (18H, s, tBu).

Compound PL10 is represented by Formula (PL10). As shown by Formula (PL10), compound PL10, is 1,8-dibromo-3,6-di-tert-butyl-9-methyl-9H-carbazole.

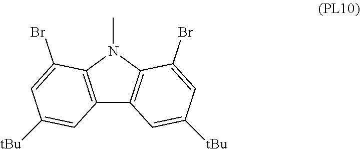 [SMILES: Cn1c2c(Br)cc(C(C)(C)C)cc2c2cc(C(C)(C)C)cc(Br)c21]

Compound PL10 is synthesized by adding N-bromosuccinimide (0.572 g, 3.21 mmol, 2.05 equiv.) to a stirring solution of compound PL9 (0.460 g, 1.57 mmol, 1 equiv.) in dimethylformamide (5 mL) at 0° C. to form a reaction mixture. The reaction mixture is allowed to come to ambient temperature and stirred overnight. CH₂Cl₂ (10 mL) is added and the mixture is washed with water (4×10 mL) then brine, dried over MgSO₄, filtered and concentrated under vacuum. The yield of the compound PL10 is 0.410 g, 0.91 mmol, 58%. The compound PL10 as characterized by ¹H NMR (400 MHz, CDCl₃) includes δ/ppm: 7.96 (2H, d, ⁴J_{HH}=1.79 Hz, Ar—H), 7.67 (2H, d, ⁴J_{HH}=1.81 Hz, Ar—H), 4.45 (3H, s, N-Me), 1.45 (18H, s, ‘Bu).

Compound PL11 is represented by Formula (PL11). As shown by Formula (PL11), compound PL11, is ((1E,1′E,1″E,1′″E)-1,1’,1″,1′″-((3,6-di-tert-butyl-9-methyl-9H-carbazole-1,8-diyl)bis(pyridine-4,2,6-triyl))tetrakis(N-mesitylethan-1-imine).

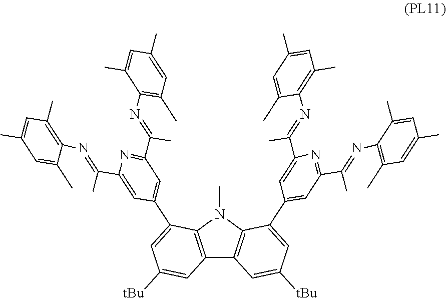

Compound PL11 is synthesized by adding a mixture of sodium carbonate (0.221 g, 2.08 mmol, 4 equiv.) in degassed water (5 mL) to a solution of compound PL10 (0.235 g, 0.52 mmol, 1 equiv.) and compound PL2 (0.613 g, 1.17 mmol, 2.25 equiv.) in dioxane (15 mL) to form a suspension. The suspension was sparged with nitrogen for 30 minutes and Pd(PPh₃)₄ (0.06 g, 0.05 mmol, 0.1 equiv.) is added. The reaction mixture was heated to 90° C. and stirred for 2 days. After cooling to ambient temperature, water (10 mL) are added, organics are separated and aqueous layer are extracted with dichloromethane (3×15 mL). Combined organics are washed with brine, dried over MgSO₄, filtered and concentrated under vacuum. The residue is washed with a very minimal amount of diethyl ether. The yield of the compound PL11 is 0.421 g, 0.39 mmol, 75%. The compound PL11 as characterized by ¹H NMR (400 MHz, CDCl₃) includes δ/ppm: 8.54 (4H, s, Pyr-H), 8.22 (2H, d, ⁴J_{HH}=1.99 Hz, Ar—H), 7.39 (2H, d, ⁴J_{HH}=1.96 Hz, Ar—H), 6.84 (8H, br. s, Ar—H), 3.18 (3H, s, N-Me), 2.30 (12H, s, Imine-Me), 2.26 (12H, s, Ar—Me), 1.95 (24H, br. s, Ar—Me), 1.50 (18H, s, ‘Bu).

Compound PL12 is represented by Formula (PL12). As shown by Formula (PL12), compound PL12, is (1E,1′E,1″E,1′″E)-1,1’,1″,1″-((3,6-di-tert-butyl-9-methyl-9H-carbazole-1,8-diyl)bis(pyridine-4,2,6-triyl))tetrakis(N-(2,6-dimethylphenyl) ethan-1-imine).

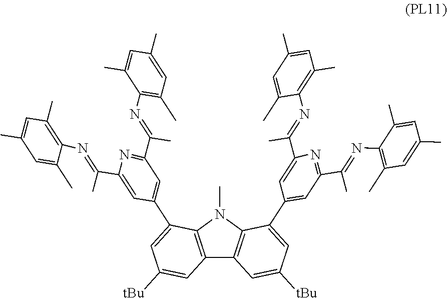

Compound PL12 is synthesized by combining a mixture of potassium carbonate (0.198 g, 1.44 mmol, 4 equiv.) in degassed water (0.12 mL) was added to a solution of compound PL10 (0.162 g, 0.36 mmol, 1 equiv.) and compound PL5 (0.40 g, 0.81 mmol, 2.25 equiv.) in dioxane (7.7 mL) to generate a reaction mixture. The suspension of the reaction mixture is sparged with nitrogen for 30 minutes and Pd(PPh₃)₄ (0.041 g, 0.04 mmol, 0.1 equiv.) is added. The reaction mixture is heated to 65° C. and stirred for 3 days. After cooling to ambient temperature, water (10 mL) are added, organics are separated and aqueous layer is extracted with dichloromethane (3×15 mL). Combined organics are washed with brine, dried over MgSO₄, filtered and concentrated under vacuum. The residue is washed with a very minimal amount of diethyl ether. The yield of the compound PL12 is 0.235 g, 0.23 mmol, 64%. The compound PL4 as characterized by ¹H NMR (400 MHz, CDCl₃) includes δ/ppm: 8.57 (4H, s, Pyr-H), 8.23 (2H, d, ⁴J_{HH}=1.9 Hz, Ar—H), 7.40 (2H, d, ⁴J_{HH}=1.9 Hz, Ar—H), 7.03 (8H, d, ³J_{HH}=7.5 Hz, Ar—H), 6.94 (4H, d, ³J_{HH}=7.4 Hz, Ar—H), 3.21 (3H, s, N-Me), 2.27 (12H, s, imine-Me), 1.99 (24H, s, Ar—Me), 1.50 (18H, s, ^{t}Bu).

Compound PL13 is represented by Formula (PL13). As shown by Formula (PL13), compound PL13, is 3,6-dibromo-9-methyl-9H-carbazole.

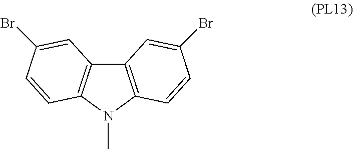 [SMILES: Cn1c2ccc(Br)cc2c2cc(Br)ccc21]

Compound PL13 is synthesized by adding sodium hydride (0.407 g, 16.94 mmol, 1.1 equiv.) slowly to a flask containing 3,6-dibromo-9-methyl-9H-carbazole (5.01 g, 15.40 mmol, 1 equiv.) in dimethylformamide (30 mL) at 0° C. to produce a reaction mixture. The reaction mixture is stirred at ambient temperature for 30 minutes at which point iodomethane (2.624 g, 18.48 mmol, 1.2 equiv.) was added. Stirring is continued at ambient temperature overnight. The reaction mixture is quenched with water and extracted with dichloromethane (3×20 mL). Combined organics are washed with brine, dried over MgSO₄, filtered and concentrated under vacuum. The yield of the compound PL13 is 4.74 g, 13.97 mmol, 91%. The compound PL13 as characterized by ¹H NMR (400 MHz, CDCl₃) δ/ppm: 8.08 (2H, d, ⁴J_{HH}=2.0 Hz, Ar—H), 7.56 (2H, dd, ³J_{HH}=8.7, ⁴J_{HH}=2.0 Hz, Ar—H), 7.22 (2H, d, ⁴J_{HH}=8.6 Hz, Ar—H), 3.76 (3H, s, N-Me).

Compound PL4 is represented by Formula (PL14). As shown by Formula (PL14), compound PL14, is (1E,1′E,1″E,1′″E)-1,1′,1″,1″-((9-methyl-9H-carbazole-3,6-diyl)bis(pyridine-4,2,6-triyl))tetrakis(N-mesitylethan-1-imine).

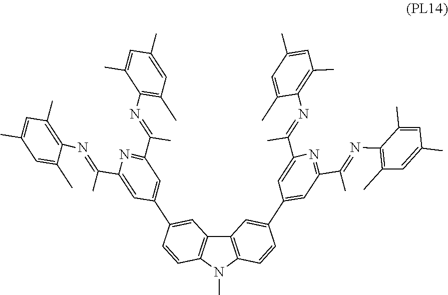

Compound PL14 is synthesized by adding Pd₂dba₃ (0.039 g, 0.042 mmol, 0.1 equiv.) and Xphos (0.020 g, 0.042 mmol, 0.1 equiv.) to a stirring suspension of compound PL13 (0.144 g, 0.43 mmol, 1 equiv.), compound PL2 (0.5 g, 0.96 mmol, 2.25 equiv.), potassium phosphate (0.270 g, 1.27 mmol, 3 equiv.), and cesium fluoride (0.097 g, 0.637 mmol, 1.5 equiv.) in dioxane/water (20 mL, 4:1 ratio) to generate a reaction mixture. The reaction mixture is heated to 90° C. and stirred overnight. After cooling to ambient temperature, water (10 mL) is added and organics are extracted with dichloromethane (3×20 mL). The residue is dried over MgSO₄, filtered and concentrated. The dark-brown crude is stirred for 10 minutes in a minimal amount of diethyl ether. A beige solid was collected via vacuum filtration giving a dark-brown filtrate. The yield of compound 14 is 0.273 g, 0.28 mmol, 66%. The compound PL14 as characterized by ¹H NMR (400 MHz, CDCl₃) includes δ/ppm: 8.90 (Pyr-H, 4H, s), 8.71 (2H, d, ⁴J_{HH}=1.8 Hz, Ar—H), 8.06 (2H, dd, ³J_{HH}=8.6, ⁴J_{HH}=1.8 Hz, Ar—H), 7.56 (2H, d, ³J_{HH}=8.6 Hz, Ar—H), 6.93 (8H, s, Ar—H), 3.97 (3H, s, N-Me), 2.35 (12H, s, imine-Me), 2.32 (12H, s, Ar—Me), 2.07 (24H, s, Ar—Me).

### Catalyst Synthesis

Example methods for producing, generating, or synthesizing the disclosed catalysts are described herein. In general, the method for producing the disclosed tethered catalysts include providing diimono pyridine ligands, providing one or more transition metal precursors (e.g., transition metal salts), and reacting under conditions such as those described below.

Catalysts may include two diimino pyridine ligands (e.g., compound PL1, PL3, PL6, PL7, PL8, PL11, PL12, PL14, and/or one or more addition ligand) tethered together using a rigid carbocyclic or heterocyclic backbone to form a bis(diiminopyridine) ligand that is complexed with an s-, p- or d-block element to form the precatalyst. The catalysts may include compounds C1, C2, C3, C4, C5, C6, C7, C8, C9, C10, C11, C12, C13, and/or one or more additional catalyst.

Catalyst C1 is represented by Formula (C1). As shown by Formula (C1), catalyst Cl, is (1E,1′E)-1,1′-(pyridine-2,6-diyl)bis(N-mesitylethan-1-imine) iron dichloride.

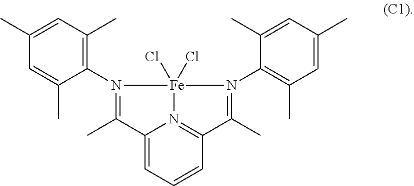

Catalyst C1 is synthesized by combining compound PL1 (150 mg, 37.7 μmol, 1 equiv.) and FeCl₂ (48 mg, 37.7 μmol, 1 equiv.) in a scintillation vial. CH₂Cl₂ (5 mL) is added to the scintillation vial resulting in a dark purple solution. The dark purple solution is stirred at ambient temperature for 18 hours. The dark purple solution was subsequently dried under a stream of nitrogen gas then under vacuum resulting in formation of solids. The solids were stirred in diethyl ether and collected on a sintered frit and washed with diethyl ether (2×3 mL) then pentane (1×5 mL) producing a purple solid (e.g., catalyst C1) which was dried under vacuum. The yield of the catalyst C1 is 176 mg, 33.6 μmol, 89%. Due to paramagnetic nature of these Fe(II) systems, spectral width was increased to ±100 to −50 ppm with not all environments being assigned. The catalyst C1 as characterized by ¹H NMR (400 MHz, CD₂Cl₂) includes δ/ppm: 81.44 (2H, s), 36.50 (1H, s), 21.57 (6H, s), 15.44 (4H, s), 12.30 (12H, br. s), −22.28 (6H, s).

Catalyst C2 is represented by Formula (C2). As shown by Formula (C2), catalyst C2, is (1E,1′E,1″E,1′″E)-1,1′,1″,1′″-((2,7-di-tert-butyl-9,9-dimethyl-9H-xanthene-4,5-diyl)bis(pyridine-4,2,6-triyl))tetrakis(N-mesitylethan-1-imine)diiron tetrachloride.

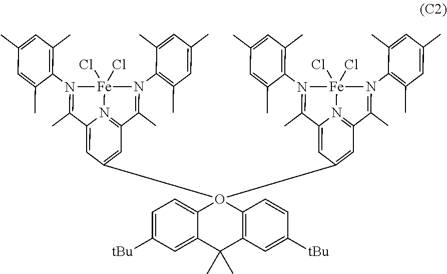

Catalyst C2 is synthesized by combining compound PL3 (100 mg, 89.8 μmol, 1 equiv.) and FeCl₂ (23 mg, 180.0 μmol, 2 equiv.) in a scintillation vial. CH₂Cl₂ (5 mL) is added to the scintillation vial resulting in a dark blue/green solution. The dark blue/green solution is stirred at ambient temperature for 18 hours. The dark blue/green solution was subsequently dried under a stream of nitrogen gas then under vacuum resulting in formation of solids. The solids were stirred in diethyl ether and collected on a sintered frit and washed with diethyl ether (2×3 mL) then pentane (1×5 mL) resulting in a dark blue solid (e.g., Catalyst C2) which was dried under vacuum. The yield of the catalyst C2 is 105 mg, 76.8 mmol, 86%. Due to paramagnetic nature of these Fe(II) systems, spectral width was increased to ±100 to −100 ppm with not all environments being assigned. The catalyst C2 as characterized by ¹H NMR (400 MHz, CD₂Cl₂) includes δ/ppm: 89.65 (4H, s), 20.55 (12H, s), 20.03 (4H, d), 14.12 (s, 8H), 13.03 (s, 2H), 6.00 (24H, br. s), 4.49 (6H, s), 4.40 (18H, s), −1.34 (2H, s), −26.83 (12H, s).

Catalyst C3 is represented by Formula (C3). As shown by Formula (C3), catalyst C3, is (1E,1′E,1″E,1′″E)-1,1′,1″,1′″-((2,7-di-tert-butyl-9,9-dimethyl-9H-xanthene-4,5-diyl)bis(pyridine-4,2,6-triyl))tetrakis(N-2,6-dimethylphenylethan-1-imine)diiron tetrachloride.

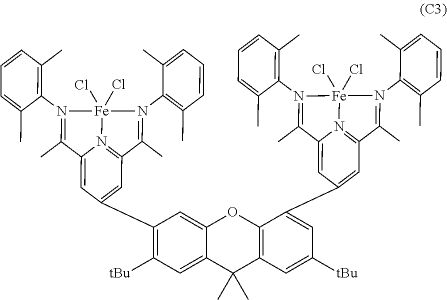

Catalyst C3 is synthesized by combining compound PL6 (106 mg, 0.1 mmol, 1 equiv.) and FeCl₂ (25 mg, 0.2 mmol, 2 equiv.) in a scintillation vial. THF (5 mL) is added to the scintillation vial resulting in a dark blue/green solution. The dark blue/green solution is stirred at ambient temperature for 18 hours. Solid precipitate was formed during the course of the reaction. After stirring for 18 hours, diethyl ether was added to crash out the solids which were collected on a sintered frit and washed with diethyl ether (2×3 mL) and pentane (1×5 mL) to leave a dark blue solid. Crystals of the catalyst C3 were obtained via solvent exchange by dissolving in CH₂Cl₂ in a dram vial which was then placed in vial of pentane and sealed. Dark blue/green blocks of the catalyst C3 were formed. The dark blue/green blocks were suitable for single crystal X-ray diffraction. The yield of the catalyst C3 is 131 mg, 0.84 mmol, 84%. Due to paramagnetic nature of these Fe(II) systems, spectral width was increased to ±150 to −45 ppm with not all environments being assigned due to line broadening. The catalyst C3 as characterized by ¹H NMR (400 MHz, CD₂Cl₂) includes δ/ppm: 90.27 (4H, s), 19.75 (2H, s), 14.43 (8H, s), 12.67 (6H, s), 4.59 (6H, s), 4.45 (18H, s), 1.27 (12H, s), 0.86 (6H, br. m), −11.31 (4H, s), −25.27 (12H, br. s).

Catalyst C4 is represented by Formula (C4). As shown by Formula (C4), catalyst C4, i (1E,1′E,1″E,1′″E)-1,1′,1″,1′″-(1,2-phenylenebis(pyridine-4,2,6-triyl))tetrakis(N-mesitylethan-1-imine)diiron tetrachloride.

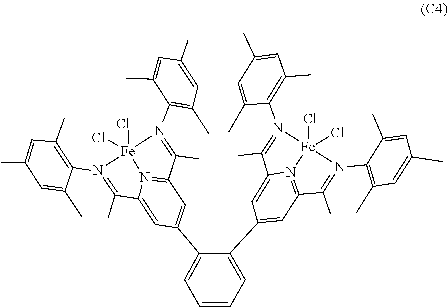

Catalyst C4 is synthesized by combining compound PL7 (100 mg, 0.12 mmol, 1 equiv.) and FeCl₂ (29.2 mg, 0.23 mmol, 2 equiv.) in a scintillation vial. THF (5 mL) was added to the scintillation vial resulting in a dark blue/green solution. The dark blue/green solution is stirred at ambient temperature for 18 hours. A green/blue solid precipitate was formed during the course of the reaction. After stirring for 18 hours, the solids which were collected on a sintered frit and washed with diethyl ether (2×3 mL) then pentane (1×5 mL) to leave a dark blue/green solid (e.g., catalyst C4). The yield of catalyst C4 is 129 mg, 0.11 mmol, 92%. Due to paramagnetic nature of these Fe(II) systems, spectral width was increased to ±100 to −100 ppm with not all environments being assigned. The catalyst C4 as characterized by ¹H NMR (400 MHz, C₂D₂Cl₄) includes δ/ppm: 82.92 (4H, s), 23.34 (12H, s), 14.73 (8H, s), 13.91 (2H, s), 11.42 (2H, s), 10.38 (24H, s), −30.00 (12H, s).

Catalyst C5 is represented by Formula (C5). As shown by Formula (C5), catalyst C5, is (1E,1′E,1″E,1′″E)-1,1′,1″,1′″-(1,2-phenylenebis(pyridine-4,2,6-triyl))tetrakis(N-mesitylethan-1-imine)diiron hexachloride.

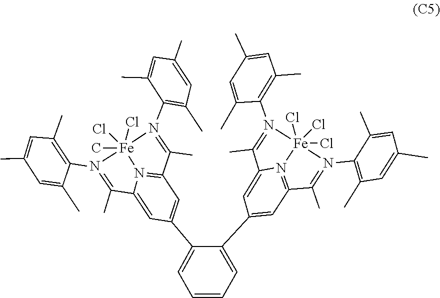

Catalyst C5 is synthesized by dissolving compound PL7 (50 mg, 57.5 μmol, 1 equiv.) in THE in a scintillation vial with FeCl₃ (19 mg, 115.0 μmol, 2 equiv.) being added as a solid producing a dark brown solution. The dark brown solution is stirred at ambient temperature for 18 hours. A precipitate that was formed during the reaction was collected on a sintered frit and washed with diethyl ether (2×3 mL) then pentane (1×5 mL) leaving a dark brown solid (e.g., catalyst C5) which was dried under vacuum. The yield of catalyst C5 is 49 mg, 41.1 μmol, 71%. Due to paramagnetic nature of these high spin Fe(III) S=5/2 systems, ¹H NMR resulted in broad ill-defined resonances.

Catalyst C6 is represented by Formula (C6). As shown by Formula (C6), catalyst C6, is (1E,1′E,1″E,1′″E)-1,1′,1″,1′″-(1,2-phenylenebis(pyridine-4,2,6-triyl))tetrakis(N-mesitylethan-1-imine)divanadium hexachloride.

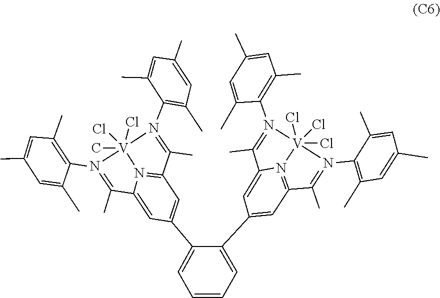

Catalyst C6 is synthesized by dissolving compound PL7 (50 mg, 57.5 μmol, 1 equiv.) in THE in a scintillation vial whereupon (THF) 3 VCl₃ (43 mg, 115.0 μmol, 2 equiv.) was added as a solid resulting in a dark brown solution. The dark brown solution is stirred at ambient temperature for 18 hours. A precipitate formed during the reaction was collected on a sintered frit and washed with then pentane (3×5 mL) until the washings ran clear. The solid was dried under vacuum to leave a dark brown solid (e.g., catalyst C6). The yield of catalyst C6 is 59 mg, 49.4 μmol, 86%. Due to paramagnetic nature of these V(III) systems, spectral width was increased to ±85 to −35 ppm. The catalyst C6 as characterized by ¹H NMR (400 MHz, CD₂Cl₂) includes δ/ppm: 60.98 (12H, s), 7.05 (2H, s), 6.93 (2H, s), 6.49 (8H, s), 4.51 (24H, s), 2.73 (12H, s), −3.92 (4H, s).

Catalyst C7 is represented by Formula (C7). As shown by Formula (C7), catalyst C7, is (1E,1′E,1″E,1′″E)-1,1′,1″,1′″-(1,2-phenylenebis(pyridine-4,2,6-triyl))tetrakis(N-mesitylethan-1-imine)dicobalt tetrachloride.

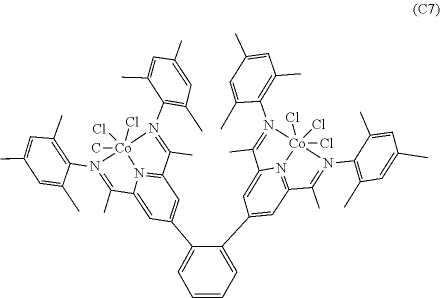

Catalyst C7 is synthesized by dissolving compound PL7 (50 mg, 57.5 μmol, 1 equiv.) in THF in a scintillation vial whereupon CoCl₂ (22 mg, 173.0 μmol, 2 equiv.) is added as a solid resulting in a dark brown solution. The dark brown solution is stirred at ambient temperature for 18 hours. A precipitate that formed during the reaction was collected on a sintered frit and washed with then pentane (3×5 mL) until the washings ran clear and dried under vacuum to leave a dark brown solid (e.g., catalyst C7). The yield of catalyst C7 is 84 mg, 74.4 μmol, 86%. Due to paramagnetic nature of these Co(II) systems, spectral width was increased to ±150 to −150 ppm. The catalyst C7 as characterized by ¹H NMR (400 MHz, CD₂Cl₂) includes δ/ppm: 127.66 (4H, br. s), 29.97 (2H, s), 19.87 (2H, s), 17.74 (12H, s), 11.75 (12H, s), 7.04 (8H, s), −27.49 (24H, br. s).

Catalyst C8 is represented by Formula (C8). As shown by Formula (C8), catalyst C8, is (1E,1′E,1″E,1′″E)-1,1′,1″,1′″-(1,2-phenylenebis(pyridine-4,2,6-triyl))tetrakis(N-mesitylethan-1-imine) iron dichloride zinc dichloride.

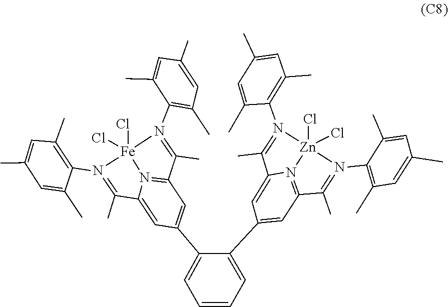

Catalyst C8 is synthesized by dissolving compound PL7 (75 mg, 86.3 μmol, 1 equiv.) in THF in a scintillation vial whereupon FeCl₂ (12 mg, 86.3 μmol, 1 equiv.) was added as a solid resulting in a dark green solution. The dark green solution was stirred at ambient temperature for 2 hours. ZnCl₂ (11 mg, 86.3 μmol, 1 equiv.) was added to the dark green solution producing a light green mixture. The light green mixture is left to stir at ambient temperature for 18 hours. The resultant precipitate formed from the light green mixture is collected on a sintered frit and washed with then pentane (3×5 mL) until the washings are clear. The solid was dried under vacuum leaving a light green solid (e.g., catalyst C8). The yield of catalyst C8 is 91 mg, 80.1 μmol, 93%. Due to paramagnetic nature of the Fe(II) systems, spectral width was increased to ±100 to −50 ppm. It was observed that in solution this compound exists as a statistical distribution of the two homometallic dinuclear complexes featuring Fe/Fe and Zn/Zn alongside the desired heterometallic dinuclear complex Fe/Zn. Integration of resonances was not performed due to overlapping with other homometallic dinuclear complexes. The catalyst C8 as characterized by ¹H NMR (400 MHz, CD₂Cl₂) includes δ/ppm: 74.73 (br. s), 23.68 (br. s), 15.04 (br. s), 14.59 (br. s), 11.56 (br. s), 10.71 (br. s), 7.21 (br. s), 6.61 (br. s), 1.97 (br. s), −37.06 (br. s).

Catalyst C9 is represented by Formula (C9). As shown by Formula (C9), catalyst C9, is (1E,1′E,1″E,1′″E)-1,1′,1″,1′″-(1,2-phenylenebis(pyridine-4,2,6-triyl))tetrakis(N-2,6-dimethylphenylethan-1-imine)diiron tetrachloride.

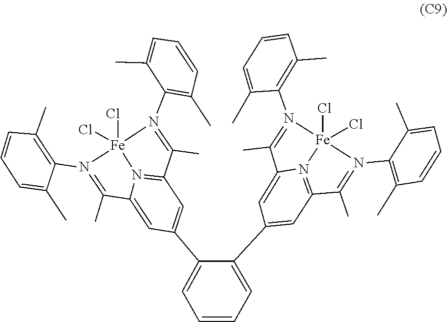

Catalyst C9 is synthesized by combining compound PL8 (150 mg, 0.18 mmol, 1 equiv.) and FeCl₂ (46.8 mg, 0.37 mmol, 2 equiv.) in a scintillation vial. THF (5 mL) was added to the scintillation vial resulting in a dark blue/green solution. The dark blue/green solution is stirred at ambient temperature for 18 hours. A solid precipitate was formed during the course of the reaction. After stirring for 18 hours, diethyl ether was added to crash out the solids which were collected on a sintered frit and washed with diethyl ether (2×3 mL) then pentane (1×5 mL) to leave a dark blue solid. Crystals of the catalyst C9 could be obtained via solvent exchange by dissolving in CH₂Cl₂ in a dram vial which was then placed in vial of pentane and sealed. Dark blue/green blocks of the catalyst C9 formed which were suitable for single crystal X-ray diffraction. The yield of catalyst C9 is 165 mg, 0.16 mmol, 84%. Due to paramagnetic nature of these Fe(II) systems, spectral width was increased to ±115 to −65 ppm with not all environments being assigned. The catalyst C9 as characterized by ¹H NMR (400 MHz, C₂D₂Cl₄) includes δ/ppm: 85.54 (4H, br. s), 15.43 (2H, br. s), 15.02 (8H, br. s), 12.69 (2H, br. s), 8.97 (24H, br. s), −13.21 (4H, br. s), −30.41 (12H, br. s).

Catalyst C10 is represented by Formula (C10). As shown by Formula (C10), catalyst C10, is (1E,1′E,1″E,1′″E)-1,1′,1″,1′-((3,6-di-tert-butyl-9-methyl-9H-carbazole-1,8-diyl)bis(pyridine-4,2,6-triyl))tetrakis(N-mesitylethan-1-imine)diiron tetrachloride.

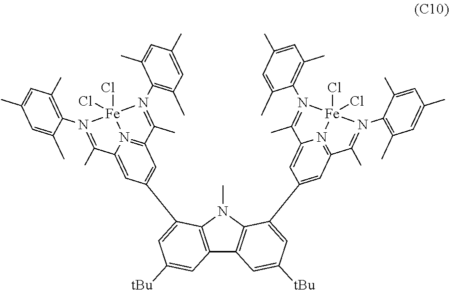

Catalyst C10 is synthesized by adding FeCl₂ (0.099 g, 0.78 mmol, 2 equiv.) to a stirring solution of compound PL11 (0.422 g, 0.39 mmol, 1 equiv.) in THF (5 mL) to generate a mixture. The mixture was allowed to stir at ambient temperature overnight. The solvent was removed, and diethyl ether was added to precipitate solids. Presence of a turbid deep green solution indicated that solids were present in the solution. However, upon collection of the solids on a fritted funnel, it appeared that the solids were of insufficient size to be collected and passed through into the filtrate. Solvent was removed under vacuum. Multiple solvents were used in attempt to obtain NMR data (CD₂C12, CD₃CN and toluene-d₈) but the solid was not sufficiently soluble to obtain spectral data. The yield of catalyst C10 is 0.165 g, 0.12 mmol, 32%.

Catalyst C11 is represented by Formula (C11). As shown by Formula (C11), catalyst C11, is (1E,1′E,1″E,1′″E)-1,1′,1″,1′″-((3,6-di-tert-butyl-9-methyl-9H-carbazole-1,8-diyl)bis(pyridine-4,2,6-triyl))tetrakis(N-2,6-dimethylphenylethan-1-imine)diiron tetrachloride.

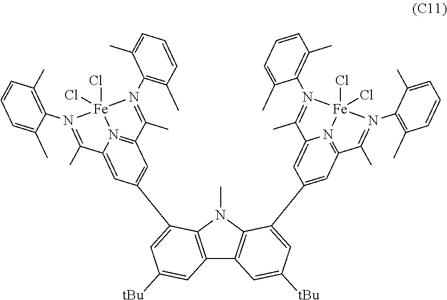

Catalyst C11 is synthesized by adding FeCl₂ (0.033 g, 0.26 mmol, 2 equiv.) to a stirring solution of compound PL12 (0.135 g, 0.13 mmol, 1 equiv.) in THF (5 mL) to form a mixture. The mixture was allowed to stir at ambient temperature overnight. The solvent was removed, and diethyl ether was added to precipitate solids. The resulting suspension was filtered through a fritted funnel. However, the solids were not of sufficient size to be collected on the frit and moved through into the filtrate. Solvent was removed under vacuum. Multiple solvents were used in attempt to obtain NMR data (CD₂C12, CD₃CN and toluene-d₈) but the solid was not sufficiently soluble to obtain spectral data. The yield of catalyst C11 is 0.097 g, 0.08 mmol, 58%.

Catalyst C12 is represented by Formula (C12). As shown by Formula (C12), catalyst C12, is (1E,1′E,1″E,1′″E)-1,1′,1″,1′-((9-methyl-9H-carbazole-3,6-diyl)bis(pyridine-4,2,6-triyl))tetrakis(N-mesitylethan-1-imine) diiron tetrachloride.

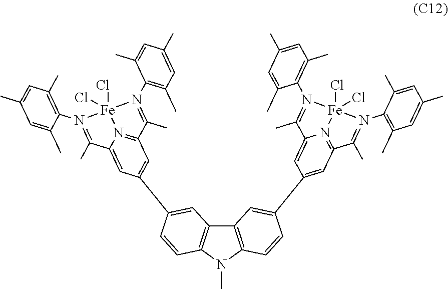

Catalyst C12 is synthesized by adding FeCl₂ (0.071 g, 0.56 mmol, 2 equiv.) to a stirring solution of compound PL14 (0.273 g, 0.28 mmol, 1 equiv.) in THF (3 mL) to form a mixture. The mixture was allowed to stir at ambient temperature overnight. The solvent was removed, and diethyl ether was added to precipitate solids. Resulting suspension is filtered through a fritted funnel. However, the solids were not of sufficient size to be collected on the frit and instead moved through into the filtrate. Solvent was removed under vacuum to yield a green powdery solid. The yield of catalyst 12 is 0.242 g, 0.20 mmol, 70%, ¹H NMR (400 MHz, CD₂Cl₂) δ/ppm: 85.41 (br.s, 4H), 21.13 (s, 12H), 15.75 (s, 8H), 12.17 (br.s, 26H), 7.73 (s, 3H), 5.20 (br. s, 4H), −17.16 (br.s, 12H).

Catalyst C13 is represented by Formula (C13). As shown by Formula (C13), catalyst C13, is (1E,1′E,1″E,1′″E)-1,1′,1″,1′-((9-methyl-9H-carbazole-3,6-diyl)bis(pyridine-4,2,6-triyl))tetrakis(N-mesitylethan-1-imine) diiron hexachloride.

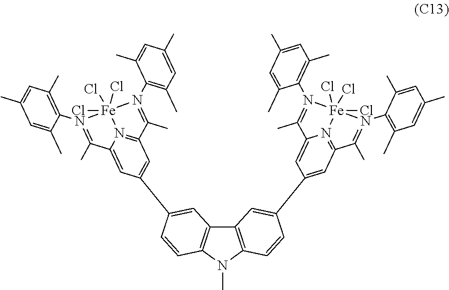

Catalyst C13 is synthesized by adding FeCl₂ (0.034 g, 0.21 mmol, 2.05 equiv.) to a stirring solution of compound PL14 (0.100 g, 0.10 mmol, 1 equiv.) in THF (1 mL) forming a mixture. The mixture was allowed to stir at ambient temperature overnight. The solvent was removed, and diethyl ether was added to precipitate solids. The resulting suspension was filtered through a fritted funnel. However, the solids were not of sufficient size to be collected on the frit and moved through into the filtrate. Solvent was removed under vacuum. The yield of the catalyst C13 is 0.072 g, 0.056 mmol, 54%. NMR data not obtained due to extremely poor solubility in all tested solvents.

Solid Polymethylaluminoxane (sMAO) Activator Synthesis

A supported catalyst comprises an activator, a support, or a combination thereof. As described herein, the supported may include a sMAO based activator embedded within the support. The support may include materials such as porous support material, for example, talc, and inorganic oxides, zeolites, clays, organoclays, or any other organic or inorganic support material and the like, or mixtures thereof.

A sMAO activator, sMAO-1, is synthesized as described herein. MAO (894 g, 30 wt % solution in toluene) is loaded into a 4 L reaction vessel with toluene (1800 g). This is stirred at 60 RPM for 5 minutes. Silica (741 g) is then loaded into the vessel over 20 minutes while stirring at 120 RPM. This is then stirred at 120 RPM at ambient temperature for 2 hours. At this time, stirring is slowed to 30 RPM with vacuum being applied to dry the supported MAO to dry for 24 hours at 60° C. The sMAO activator (e.g., a dried product) was collected, sieved and transferred without further rinsing. The yield of the sMAO activator is 1008 g with MAO loading of 4.41 mmol Al/g SMAO.

A fluorinated sMAO activator, sMAO-2, and a heated fluorinated sMAO activator, sMAO-3, are synthesized as described below. Synthesis conditions such as certain conditions described in U.S. Application Ser. No. 63/506,536, U.S. Application Ser. No. 63/506,541, U.S. Application Ser. No. 63/506,543, which are incorporated herein by reference. Generally, a 125 mL celstir vessel is charged with ES70 (400 C) (20 g) and toluene (120 g) generating a slurry. The slurry is stirred for 15 minutes. A MAO solution (28 g, 7.0 mmol MAO/g silica, 140 mmol Al) is added to the slurry. The slurry was stirred at room temp for 1 hour, and heated in an oil bath for 3 hours at 90° C. The slurry is cooled to ambient temperature. Into a separate vial, a solution of TMA (0.914 g, 12.7 mmol) is placed followed by slow addition of (NH₄)₂SiF₆ (0.286 g, 1.61 mmol). The solution was then added to the slurry, rinsing the vial with toluene (1 mL) forming a reaction slurry. The reaction slurry is stirred for 1 hour. The reaction slurry is partitioned into two equal portions, a first portion and a second portion. The first portion is filtered, washed with hexane then dried under vacuum for 4 hours leaving the sMAO-2 (e.g., the fluorinated sMAO activator) (15.7 g). The second portion is heated to 60° C. for 1 hour then filtered and rinsed with hexane followed by drying under vacuum for 4 hours to yield the sMAO-3 (e.g., heated fluorinated sMAO activator) (13.8 g).

An ionic sMAO activator (e.g., i-sMAO), sMAO-4, is synthesized as described below. A 20 mL vial is charged with sMAO (3.02 g) and toluene (12 g). The vial is capped and heated on heating plate at 90° C. for 3 hours and periodically shaken. After 3 hours, the vial and a slurry within, is allowed to cool to ambient temperature. Into the slurry, a mixture of TMA (80.1 mg) and OMTS (268 mg) is added, with the vial being rinsed with toluene (1 mL) into the slurry. The slurry is subsequently shaken on a shaker for 1 hour, and heated at 90° C. for 30 minutes. The slurry is filtered and washed with isohexane and dried under vacuum for 1 hour yielding the sMAO-4 (e.g., the ionic sMAO activator).

### Supported Catalyst Synthesis

In some embodiments, the disclosed dinuclear tethered catalysts may be provided as a catalyst system, wherein the dinuclear tethered catalysts are supported with an activator. The catalyst systems may include one or more catalysts supported by the sMAO activator (e.g., sMAO-1, sMAO-2, sMAO-3) and/or one of more support materials. That is, catalysts Cl, C2, C3, C4, C5, C6, C7, C8, C9, C10, C11, C12, C13, and/or one or more additional catalysts may be supported by the sMAO activator and/or one of more additional support materials. The supported catalysts may include compounds S1, S2, S3, S4, S5, S6, S7, S8, S9, S10, and/or one or more additional supported catalyst.

The supported catalyst S1 includes the catalyst C1 and the sMAO-1 activator. The supported catalyst S1 is synthesized in a scintillation vial, by adding 1 g of sMAO-1 and 10 mL toluene. The scintillation vial is shaken gently resulting in a white slurry. Catalyst C1 (21 mg, 40 μmol) is added to the white slurry and placed on an orbital shaker for 18 hours at ambient temperature to form a slurry. The slurry is filtered on a glass frit and subsequently washed with 10 mL toluene followed by 10 mL pentane. A produced solid is collected in an additional scintillation vial and dried under high vacuum to constant weight to yield the supported catalyst S1 as a brown/orange free flowing powder.

The supported catalyst S2 includes the catalyst C1 and the sMAO-4 activator. The supported catalyst S2 is synthesized in a scintillation vial, by adding 500 mg of the sMAO-4 (e.g., the ionic-sMAO) followed by 5 mL toluene to a vial. The vial was shaken gently together resulting in a white slurry. The catalyst C1 (10.4 mg, 20 μmol) is added to the white slurry and placed on an orbital shaker for 18 hours at ambient temperature. The slurry is filtered on a glass frit and subsequently washed with 10 mL toluene followed by 10 mL pentane. A solid was collected in an additional scintillation vial and dried under high vacuum to constant weight to yield the supported catalyst S2 as a brown free flowing powder.

The supported catalyst S3 includes the catalyst C1 and the sMAO-2 activator. The supported catalyst S3 is synthesized in a scintillation vial, by adding 400 mg of fluorinated-sMAO followed by 5 mL toluene to a vial. The vial is shaken gently resulting in a white slurry. The catalyst C1 (6.3 mg, 12 μmol) is added to the white slurry and placed on an orbital shaker for 18 hours at ambient temperature. The slurry was filtered on a glass frit and subsequently washed with 10 mL toluene followed by 10 mL pentane. A solid from the slurry was collected in an additional scintillation vial and dried under high vacuum to constant weight to yield the supported catalyst S3 as a brown/orange free flowing powder.

The supported catalyst S4 includes the catalyst C1 and the sMAO-3 activator. The supported catalyst S4 is synthesized in a scintillation vial, by adding 400 mg of heated fluorinated-sMAO followed by 5 mL toluene to a vial. The vial is shaken gently resulting in a white slurry. The catalyst C1 (6.3 mg, 12 μmol) is added to the white slurry and placed on an orbital shaker for 18 hours at ambient temperature. The slurry was filtered on a glass frit and subsequently washed with 10 mL toluene followed by 10 mL pentane. A solid from the slurry was collected in an additional scintillation vial and dried under high vacuum to constant weight to yield the supported catalyst S4 as a brown free flowing powder.

The supported catalyst S5 includes the catalyst C2 and the sMAO-1 activator. The supported catalyst S5 is synthesized in a scintillation vial, by adding 1 g of sMAO-1 and 10 mL toluene. The scintillation vial is shaken gently resulting in a white slurry. Catalyst C2 (55 mg, 40 μmol) is added to the white slurry and placed on an orbital shaker for 18 hours at ambient temperature to form a slurry. The slurry is filtered on a glass frit and subsequently washed with 10 mL toluene followed by 10 mL pentane. A produced solid is collected in an additional scintillation vial and dried under high vacuum to constant weight to yield the supported catalyst S5 as a brown/orange free flowing powder.

The supported catalyst S6 includes the catalyst C4 and the sMAO-1 activator. The supported catalyst S6 is synthesized in a scintillation vial, by adding 1 g of sMAO-1 and 10 mL toluene. The scintillation vial is shaken gently resulting in a white slurry. Catalyst C4 (45 mg, 40 μmol) is added to the white slurry and placed on an orbital shaker for 18 hours at ambient temperature to form a slurry. The slurry is filtered on a glass frit and subsequently washed with 10 mL toluene followed by 10 mL pentane. A produced solid is collected in an additional scintillation vial and dried under high vacuum to constant weight to yield the supported catalyst S6 as a brown/orange free flowing powder.

The supported catalyst S7 includes the catalyst C4 and the sMAO-4 activator. The supported catalyst S7 is synthesized in a scintillation vial, by adding 500 mg of the sMAO-4 (e.g., the ionic-sMAO) followed by 5 mL toluene to a vial. The vial was shaken gently together resulting in a white slurry. The catalyst C4 (17.5 mg, 15.6 μmol) is added to the white slurry and placed on an orbital shaker for 18 hours at ambient temperature. The slurry is filtered on a glass frit and subsequently washed with 10 mL toluene followed by 10 mL pentane. A solid was collected in an additional scintillation vial and dried under high vacuum to constant weight to yield the supported catalyst S7 as a brown/orange free flowing powder.

The supported catalyst S8 includes the catalyst C4 and the sMAO-2 activator. The supported catalyst S8 is synthesized in a scintillation vial, by adding 400 mg of fluorinated-SMAO (e.g., sMAO-2) followed by 5 mL toluene to a vial. The vial is shaken gently resulting in a white slurry. The catalyst C4 (22.4 mg, 20 μmol) is added to the white slurry and placed on an orbital shaker for 18 hours at ambient temperature. The slurry was filtered on a glass frit and subsequently washed with 10 mL toluene followed by 10 mL pentane. A solid from the slurry was collected in an additional scintillation vial and dried under high vacuum to constant weight to yield the supported catalyst S3 as a brown/orange free flowing powder.

The supported catalyst S9 includes the catalyst C4 and the sMAO-3 activator. The supported catalyst S9 is synthesized in a scintillation vial, by adding 400 mg of heated fluorinated-sMAO (e.g., sMAO-3) followed by 5 mL toluene to a vial. The vial is shaken gently resulting in a white slurry. The catalyst C4 (22.4 mg, 20 μmol) is added to the white slurry and placed on an orbital shaker for 18 hours at ambient temperature. The slurry was filtered on a glass frit and subsequently washed with 10 mL toluene followed by 10 mL pentane. A solid from the slurry was collected in an additional scintillation vial and dried under high vacuum to constant weight to yield the supported catalyst S9 as a brown/orange free flowing powder.

The supported catalyst S10 includes the catalyst C5 and the sMAO-1 activator. The supported catalyst S10 is synthesized in a scintillation vial, by adding 1 g of sMAO-1 and 10 mL toluene. The scintillation vial is shaken gently resulting in a white slurry. Catalyst C5 (48 mg, 40 μmol) is added to the white slurry and placed on an orbital shaker for 18 hours at ambient temperature to form a slurry. The slurry is filtered on a glass frit and subsequently washed with 10 mL toluene followed by 10 mL pentane. A produced solid is collected in an additional scintillation vial and dried under high vacuum to constant weight to yield the supported catalyst S6 as a lilac/grey free flowing powder.

### Density Functional Theory (DFT) Measurements

DFT calculations were generated utilizing the Schrodinger software embedded within the Maestro Materials Science software suite v 5.3.132 2024-1 release. DFT calculations were performed using the B₃LYP functional with van der Waals dispersion corrections included via Grimme's “D3” corrections (B₃LYP-D3). A split basis set was utilized where the Def2-TZVP basis set was used for iron atoms with the LACVP basis set being used for all non-iron atoms. DFT calculations were calculated in vacuo with no solvation.

Table 1 includes metal-metal distances of M¹ and M² of catalysts C2, C4, C5, C10, and C12. Table 1 also includes metal-metal distances of catalysts CXa, CXb, CXc, CXd, and CXe. The structures for catalysts CXa-CXe are shown below.

Catalyst CXa is represented by Formula (CXa). As shown by Formula (CXa), catalyst CXa, is (1E,1′E,1″E,1′″E)-1,1′,1″,1′″-(1,3-phenylenylbis(pyridine-4,2,6-triyl))tetrakis(N-mesitylethan-1-imine) diiron tetrachloride.

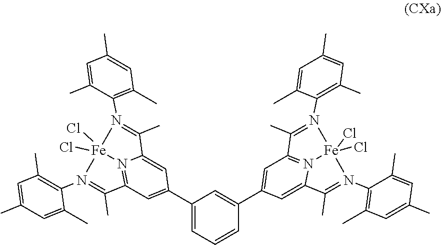

Catalyst CXb is represented by Formula (CXb). As shown by Formula (CXb), catalyst CXb, is (1E,1′E,1″E,1′″E)-1,1′,1″,1′″-(1,8-anthracenylbis(pyridine-4,2,6-triyl))tetrakis(N-mesitylethan-1-imine) diiron tetrachloride.

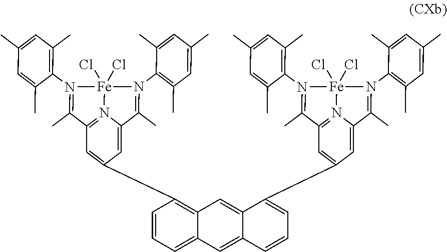

Catalyst CXc is represented by Formula (CXc). As shown by Formula (CXc), catalyst CXc, is (1E,1′E,1″E,1′″E)-1,1′,1″,1′″-(1,8-biphenylenylbis(pyridine-4,2,6-triyl))tetrakis(N-mesitylethan-1-imine) diiron tetrachloride.

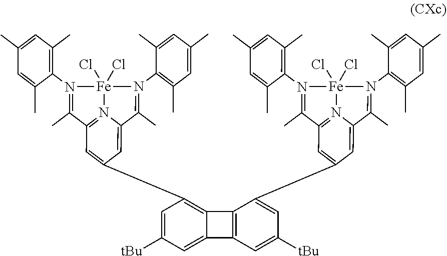

Catalyst CXd is represented by Formula (CXd). As shown by Formula (CXd), catalyst CXd, is (1E,1′E,1″E,1′″E)-1,1′,1″,1′-(3,6-phenanthrenylbis(pyridine-4,2,6-triyl))tetrakis(N-mesitylethan-1-imine) diiron tetrachloride.

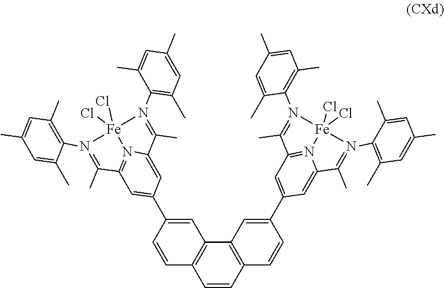

Catalyst CXe is represented by Formula (CXe). As shown by Formula (CXe), catalyst CXe, is (1E,1′E,1″E,1′″E)-1,1′,1″,1′″-(1,8-phenanthrenylbis(pyridine-4,2,6-triyl))tetrakis(N-mesitylethan-1-imine) diiron tetrachloride.

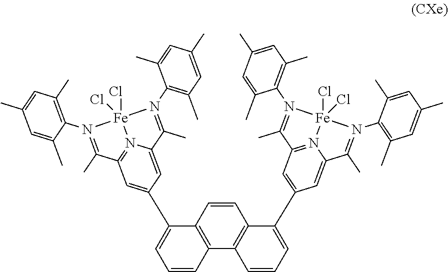

The metal-metal distances between M¹ and M² is between about 5 Å and about 16 Å as determined using Density Functional Theory. It should be noted that the metal-metal distances as provided in Table 1 are non-limiting embodiments and one or more additional metal-metal distances are envisioned. For example, the metal-metal distance may be between about 6 Å to about 15 Å, about 6 Å to about 11 Å, about, 6 Å to about 8 Å, 7 Å to about 8 Å, or 7.0 Å to about 7.2 Å. Further, the metal-metal distance may be approximately 7.05 Å, approximately 7.26 Å, approximately 7.95 Å, or approximately 13.34 Å.

TABLE 1

| Catalyst | C2 | C4 | C10 | C12 | CXa | CXb | CXc | CXd | CXe |
|---|---|---|---|---|---|---|---|---|---|
| M-M (Å) | 7.055 | 7.262 | 7.945 | 15.365 | 13.343 | 7.024 | 6.498 | 10.450 | 10.764 |

Table 1 includes metal-metal distances of M¹ and M² of various catalyst systems.

### Solution Phase Polymerization Processes

Additional aspects of the disclosure include methods for forming polymers using the disclosed dinuclear tethered catalysts and/or dinuclear tethered catalyst systems. Example polymerization reactions in accordance with the disclosed techniques are described below.

Polymerizations were conducted in an inert atmosphere (N₂) drybox using autoclaves equipped with an external heater for temperature control, glass inserts (internal volume of reactor 23.5 mL for C₂ containing runs), septum inlets, regulated supply of nitrogen, ethylene and propylene, and equipped with disposable polyether ether ketone mechanical stirrers (800 RPM). Autoclaves were prepared by purging with dry nitrogen at 110° C. or 115° C. for 5 hours and then at 25° C. for 5 hours. Toluene was added via syringe. A reactor was then brought to process temperature (80° C. or 100° C.) while stirring at 800 RPM. An activator solution, followed by a slurry containing one or more of the catalysts, were injected via syringe to the reactor at process conditions. Reactor temperature was monitored and typically maintained within ±1° C. Polymerizations were halted by addition of approximately 50 psi compressed dry air gas mixture to the autoclaves for approximately 30 seconds.

Polymerizations were quenched based on a predetermined pressure loss (maximum quench value) or for a maximum of 30 minutes. The reactors were cooled and vented. Polymers were isolated after the solvent was removed in-vacuo. Quench time is reported in seconds. Yields disclosed herein include total weight of polymer and residual catalyst. Catalyst activity is reported as grams of polymer per mmol transition metal compound per atmosphere operating pressure per hour of reaction time (Kg/mmol/atm/hr). It should be noted that these reaction conditions are meant to be non-limiting, and that these reaction conditions (e.g., temperature, time, pressures) may be adjusted as understood by one of ordinary skill in the art.

Polymer sample solutions used for performing analytical measurements were prepared by dissolving polymer in 1,2,4-tri chlorobenzene (TCB, 99+% purity from Fischer Scientific) containing 2,6-di-tert-butyl-4-methylphenol (BHT, 99% from Aldrich) at 165° C. in a shaker oven for approximately 3 hours. The concentration of polymer in solution is between about 0.1 mg/mL to about 0.9 mg/mL with a BHT concentration of about 1.25 mg BHT/mL of TCB. The solutions were cooled to 135° C. for testing.

Table 2 through table 5 show examples chemical and physical characteristics of ethylene polymerization using catalyst systems described herein. In general, Tables 2-5 show yield, catalyst activity, Mn, Mw, Mz, melting temperature (Tm), and change in enthalpy for one or more catalysts at a set temperature, pressure, and quench time. As used herein, “PE run #” represents a sample name and number. Temperatures (e.g., T (C)) presented in Tables 2-5 correspond to polymerization temperature maintained within about ±1° C. “Yield” presented in Tables 2-5 correspond to polymer yield not corrected for catalyst residue. “Quench time(s)” presented in Tables 2-5 correspond to a duration of the polymerization run in seconds. Unless otherwise specified, polymerization conditions of results presented in Tables 2-5 correspond to about 25 or 15 nmol catalyst complex, about 250 or 500 equivalents of MAO activator, with a total volume of approximately 5 mL, and toluene as solvent. Values of quench time include approximately 15 psi pressure loss and/or a maximum reaction time of 30 minutes.

Analysis of samples provided in Tables 2-5 was conducted using high temperature size exclusion chromatography using an automated “Rapid GPC” system as described in U.S. Pat. Nos. 6,491,816; 6,491,823; 6,475,391; 6,461,515; 6,436,292; 6,406,632; 6,175,409; 6,454,947; 6,260,407; and 6,294,388; each of which is incorporated herein by reference. Molecular weights (weight average molecular weight (Mw), number average molecular weight (Mn) and z average molecular weight (Mz)) and molecular weight distribution (MWD=Mw/Mn) (e.g., polydispersity) are measured by Gel Permeation Chromatography using a Symyx Technology GPC equipped with evaporative light scattering detector (ELSD) and calibrated using polystyrene standards (Polymer Laboratories: Polystyrene Calibration Kit S-M-10: Mp (peak Mw) between 5,000 and 3,390,000). Additionally, and/or alternatively, samples are measured by Gel Permeation Chromatography using a Symyx Technology GPC equipped with dual wavelength infrared detector and calibrated using polystyrene standards (Polymer Laboratories: Polystyrene Calibration Kit S-M-10: Mp (peak Mw) between 580 and 3,039,000). Samples (250 μL of a polymer solution in TCB were injected into the system) were run at an eluent flow rate of 2.0 mL/minute (135° C. sample temperatures, 165° C. oven/columns) using three Polymer Laboratories: PLgel 10 μm Mixed-B 300×7.5 mm columns in series. Column spreading corrections were not employed. Numerical analyses were performed using Epoch® software available from Symyx Technologies or Automation Studio software available from Freeslate. Molecular weights reported herein are relative to linear polystyrene standards. Molecular weight data is reported in Tables 2-5 under the headings Mn, Mw, Mz and PDI as defined above.

Analysis of samples provided in Table 2-5 was conducted using differential Scanning calorimetry (DSC) measurements on a TA-Q200 instrument to determine melting point of one or more polymer samples generated. The polymer samples were preannealed at 170° C. for 15 minutes and allowed to cool to ambient temperature overnight. The polymer samples were heated to 220° C. at a rate of 100° C./minute and cooled at a rate of 50° C./minute. Melting points were collected during the heating period. The results are reported in Tables 2-5 under the heading, Tm (° C.) and first enthalpy change, ΔH (J/g).

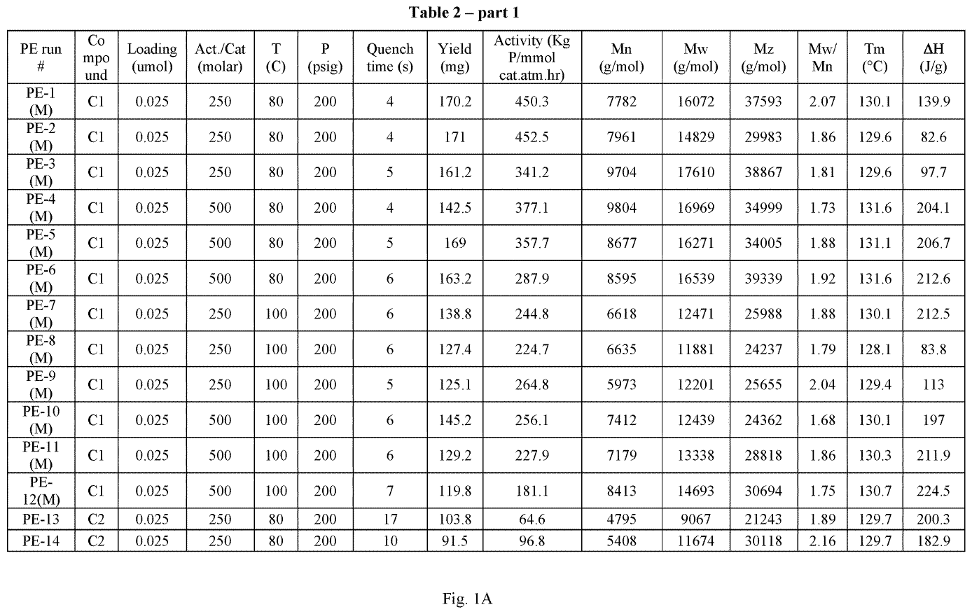

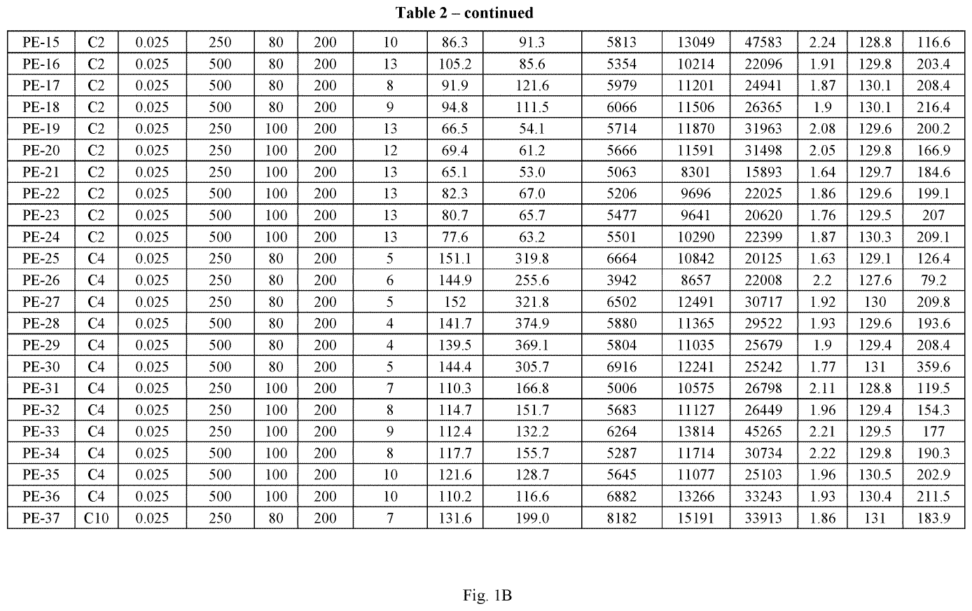

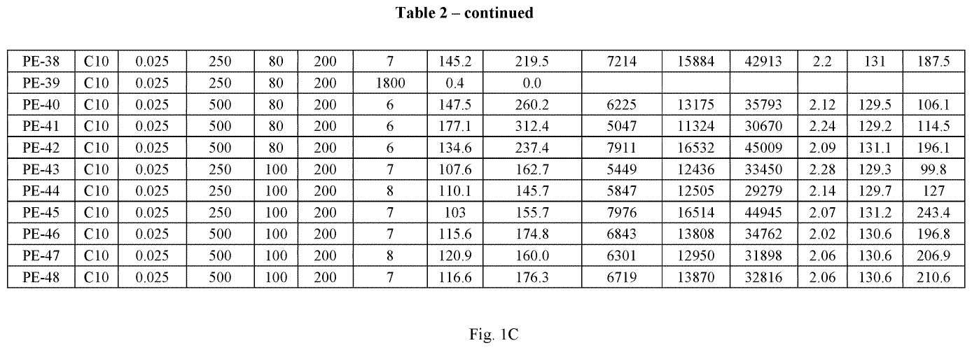

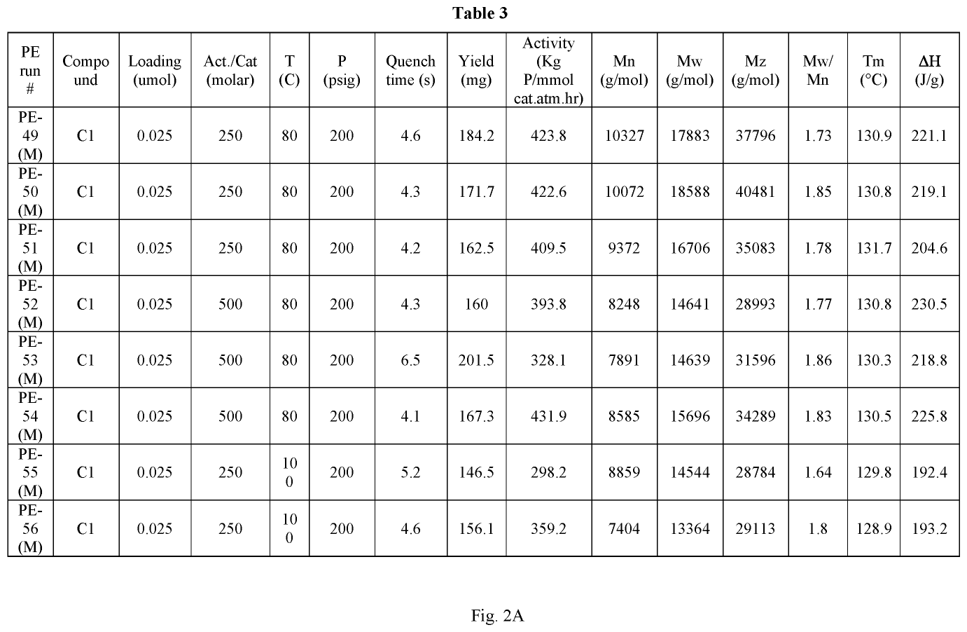

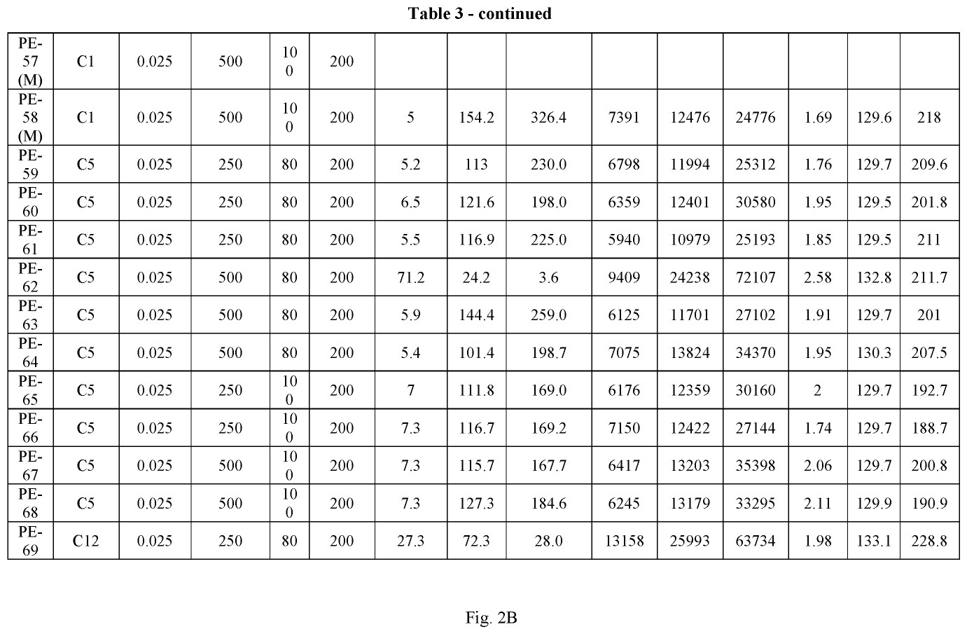

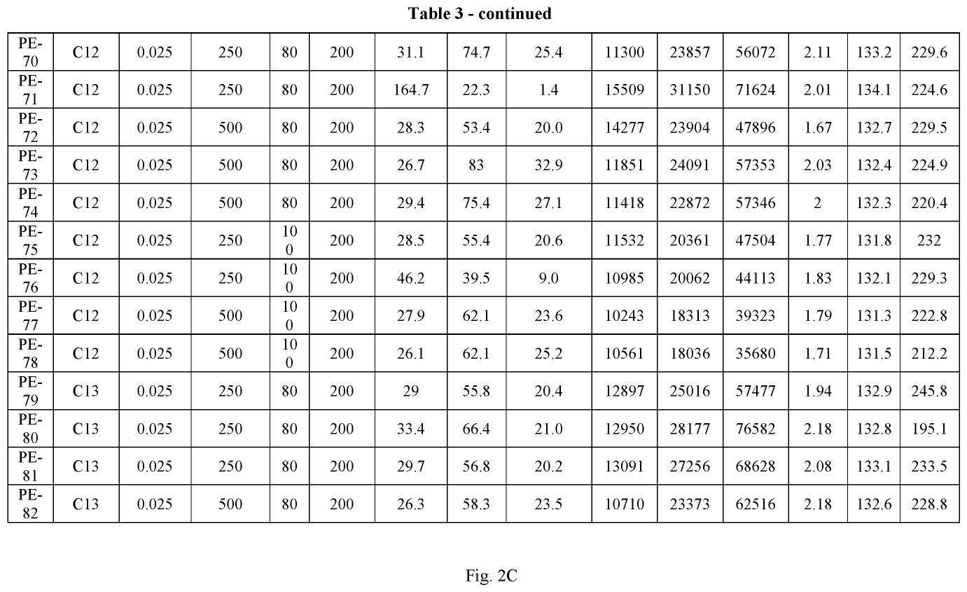

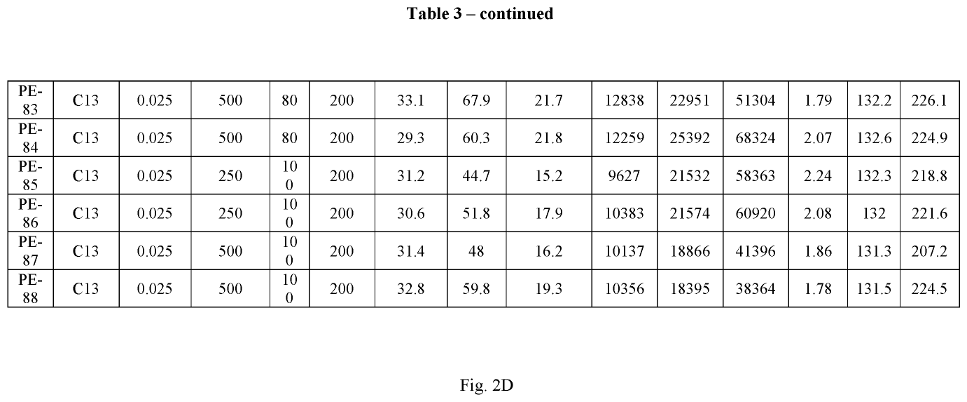

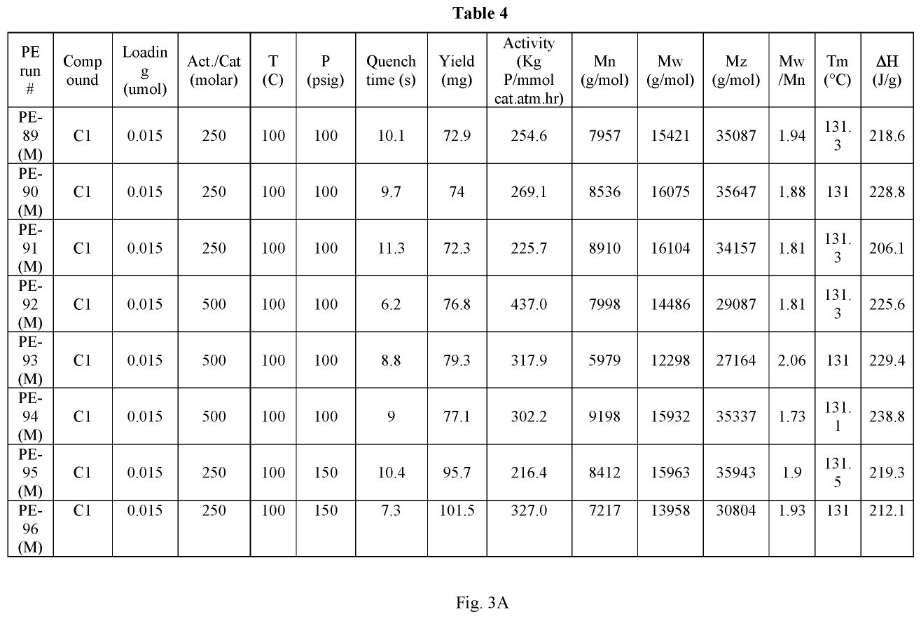

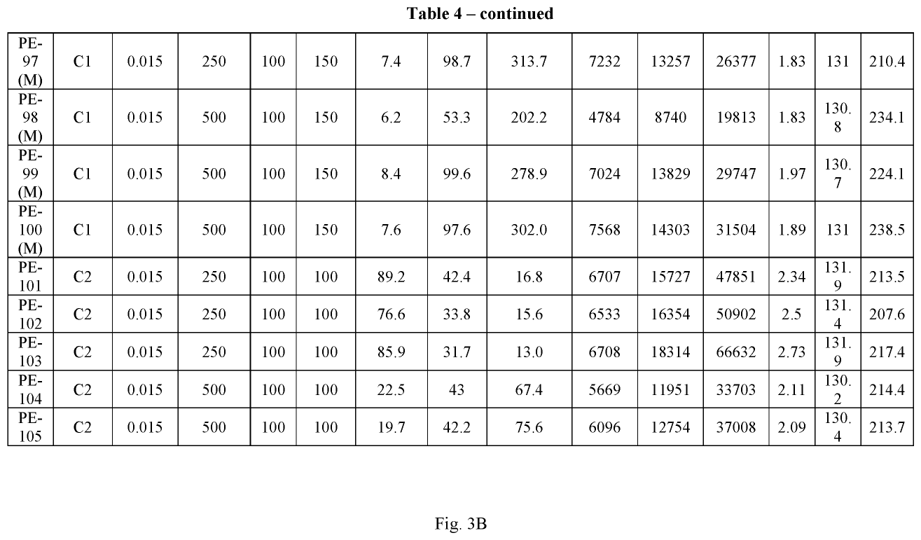

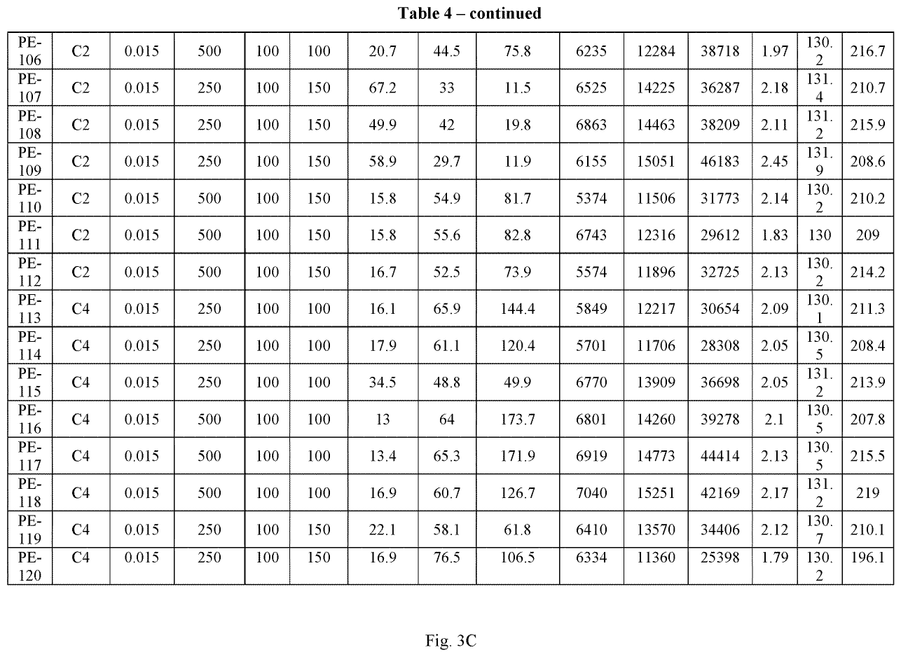

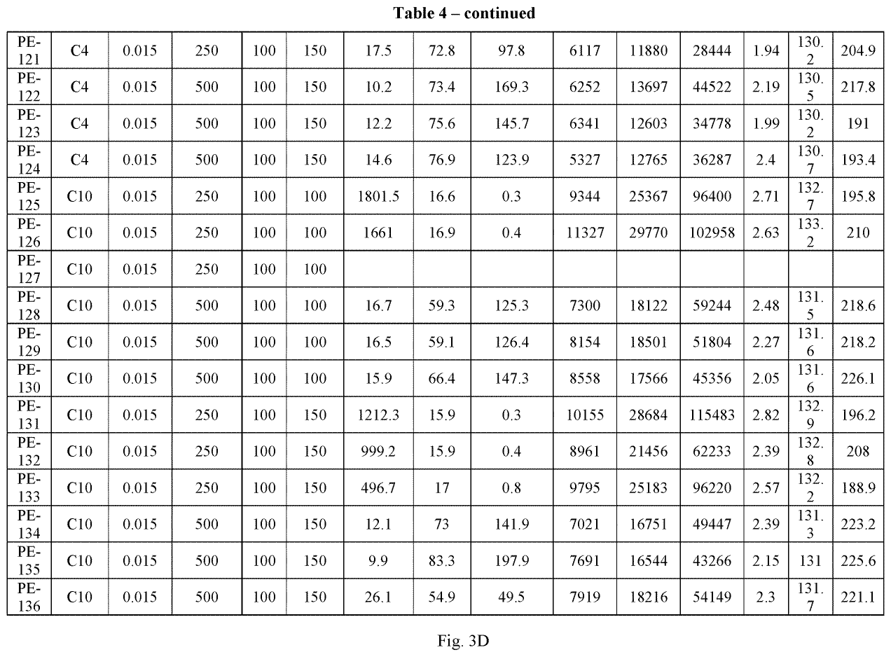

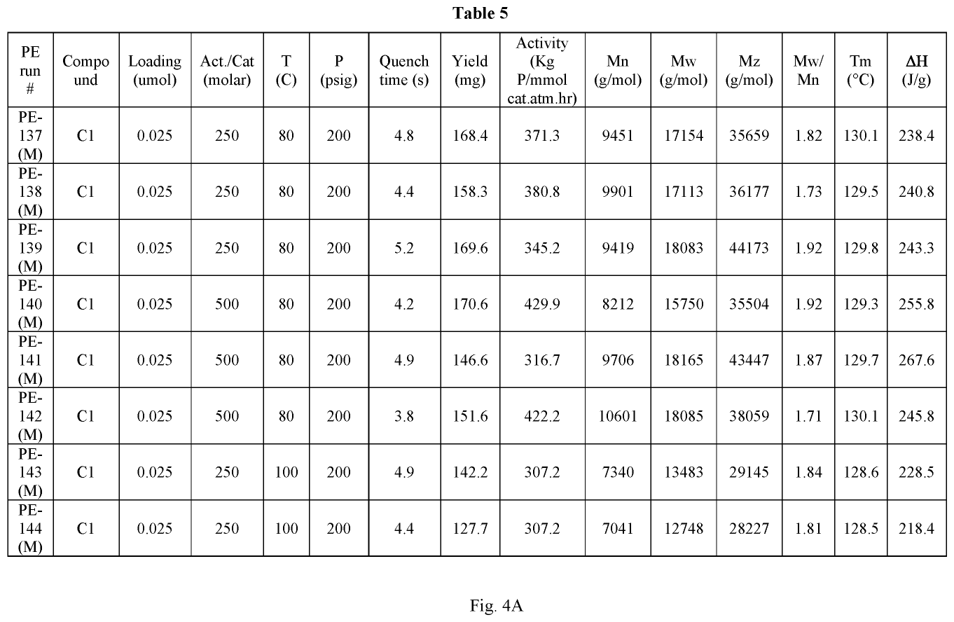

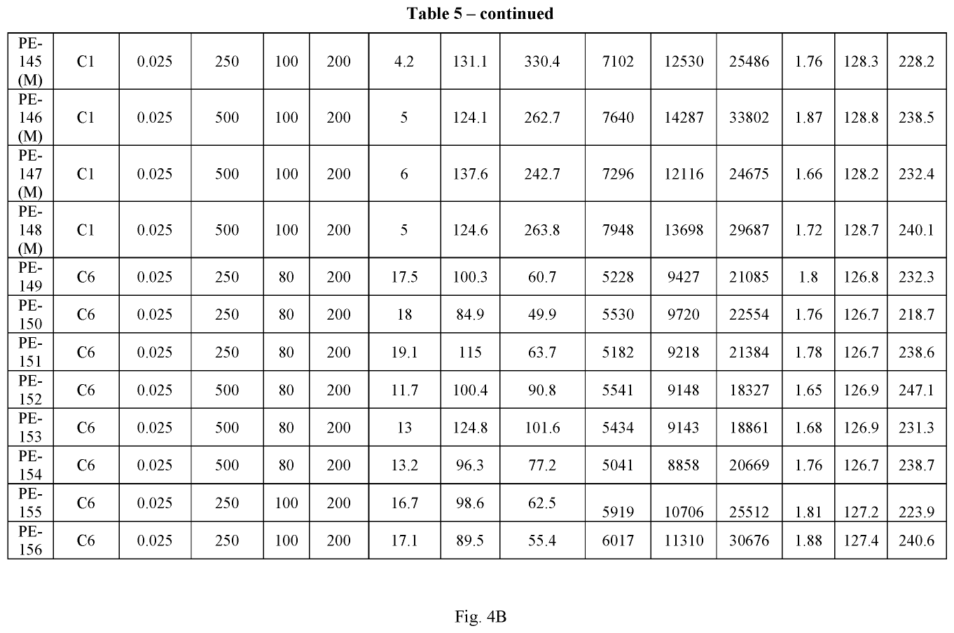

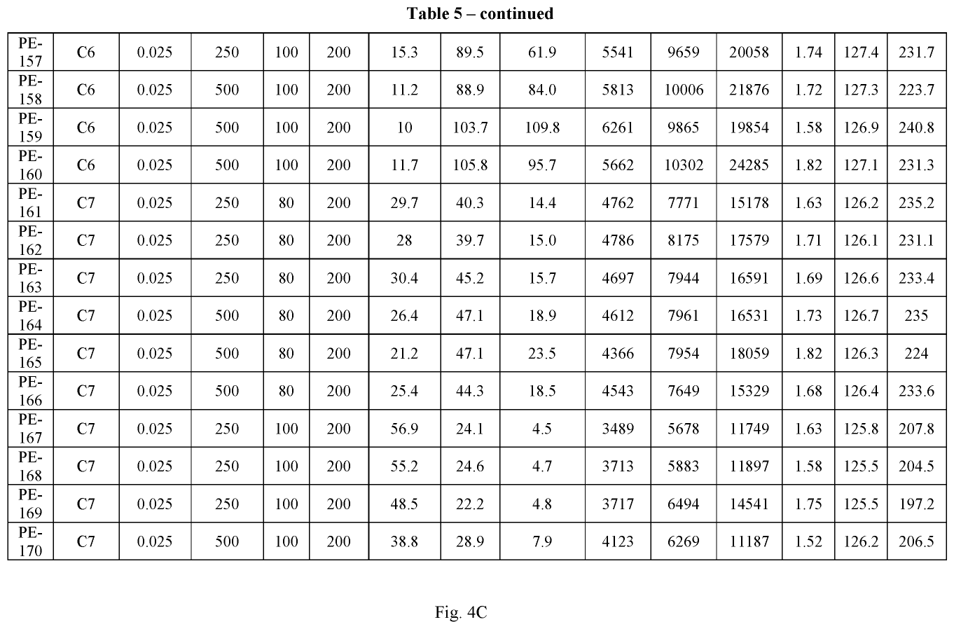

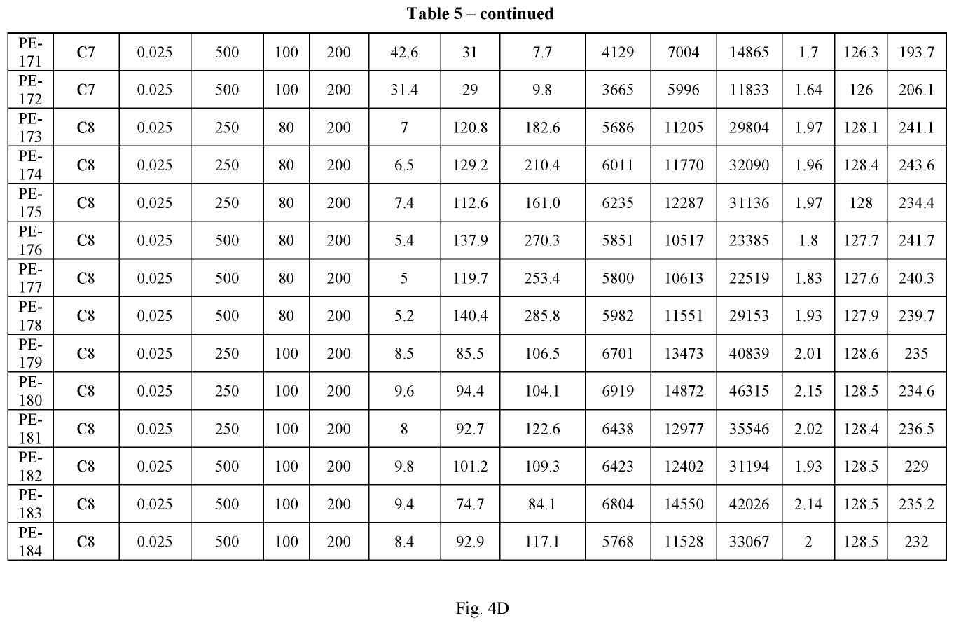

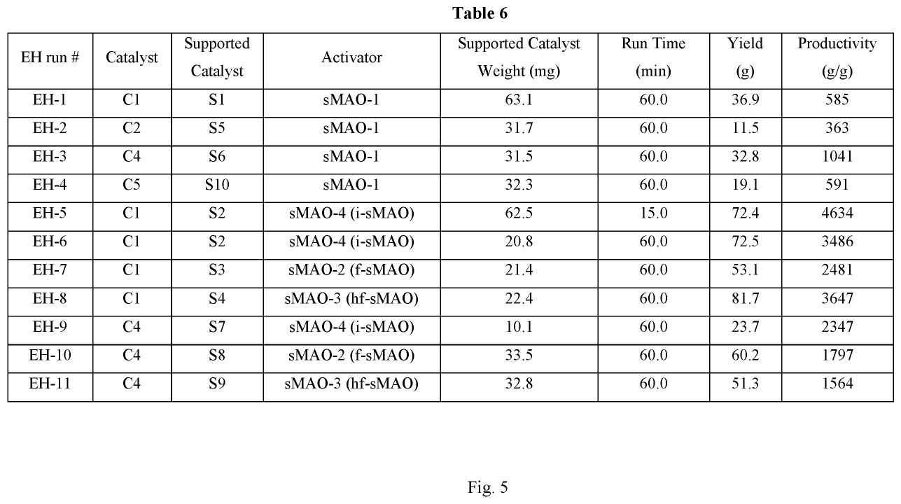

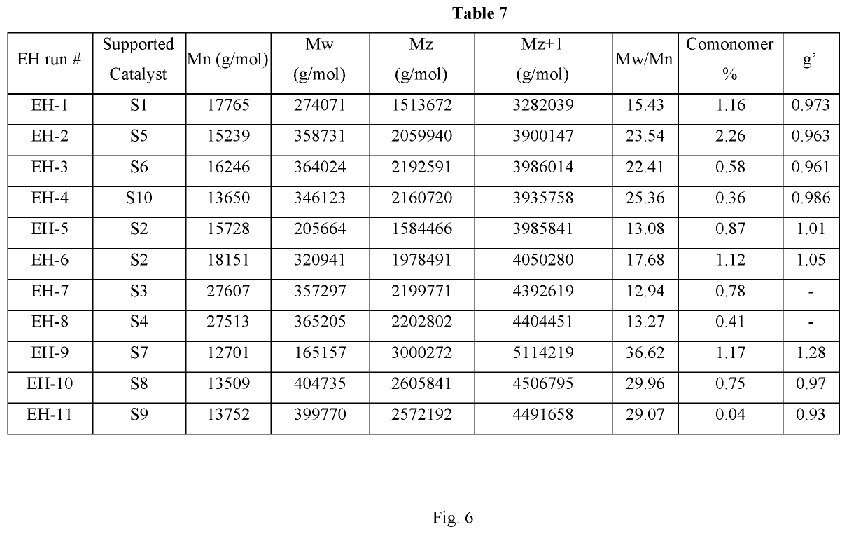

FIGS. 1A-C, Table 2 shows properties of polymerization samples produced by monometallic and dinuclear catalysts and includes mononuclear samples PE-1 (M) through PE-12 (M) and dinuclear samples PE-13 through PE-48. Mononuclear samples PE-1 (M) through PE-12 (M) include polymerization data using catalyst C1. Dinuclear samples PE-13 through PE-24 include polymerization data using catalyst C2, dinuclear samples PE-25 through PE-36 include polymerization data using catalyst C4, and dinuclear samples PE-37 through PE-48 include polymerization data using catalyst C10. As shown in Table 2, catalyst C4 and catalyst C10 demonstrate reduced activities when compared to catalyst Cl, however it should be noted that catalyst C4 and catalyst C10 are productive catalysts for ethylene polymerization. Catalyst C2 when compared to catalyst C1 demonstrates diminished activity, however, may be used for ethylene polymerization.

Table 3 includes mononuclear samples PE-49 (M) through PE-58 (M) and dinuclear samples PE-59 through PE-88. Mononuclear samples PE-49 (M) through PE-58 (M) include polymerization data using catalyst C1. Dinuclear samples PE-59 through PE-68 include polymerization data using catalyst C5, dinuclear samples PE-69 through PE-78 include polymerization data using catalyst C12, and dinuclear samples PE-79 through PE-88 include polymerization data using catalyst C13. As shown, catalyst C12 and catalyst C13 polymerize ethylene with increased Mw and Tm. For example, the Mw of the polymer produced using catalyst C12 may range between 10561 to 15509 g/mol. Further, the Mw of catalyst C12 may range between 12000 and 16000 g/mol, between 13000 and 15000 g/mol, approximately 12000 g/mol, or approximately 13000 g/mol. The Tm of catalyst C12 may range between 131° C. to 135° C., 131.5° C. to 134.1° C., 131.5° C. to 133.2° C., approximately 132° C., approximately 133° C., or approximately 133.2° C. For example, the Mw of the polymer produced using catalyst C13 may range between 9600 to 13500 g/mol. Further, the Mw of catalyst C13 may range between 10000 and 13000 g/mol, between 11000 and 12000 g/mol, approximately 11000 g/mol, or approximately 12000 g/mol. The Tm of catalyst C13 may range between 131° C. to 135° C., 131.5° C. to 133.1° C., 132.0° C. to 133.2° C., approximately 132° C., approximately 133.2° C., or approximately 132.3° C. Without wishing to be bound by theory, the increased Mw and Tm values generated by catalyst C12 and catalyst C13 may be indicative of polymers generated with improved mechanical properties (e.g., tensile strength, impact resistance, long chain branching, and the like). As such, catalyst C12 and catalyst C13 may provide advantageous conditions for olefin polymerization.

Table 4 includes mononuclear samples PE-89 (M) through PE-100 (M) and dinuclear samples PE-101 through PE-136. Mononuclear samples PE-89 (M) through PE-100 (M) include polymerization data using catalyst C1. Dinuclear samples PE-101 through PE-112 include polymerization data using catalyst C2, dinuclear samples PE-113 through PE-124 include polymerization data using catalyst C4, and dinuclear samples PE-125 through PE-136 include polymerization data using catalyst C10. As shown, Table 4 demonstrates polymerization conditions when the loading of the catalyst compound is reduced (e.g., comparatively to Table 2 and 3).

Table 5 includes mononuclear samples PE-137 (M) through PE-148 (M) and dinuclear samples PE-149 through PE-184. Mononuclear samples PE-137 (M) through PE-148 (M) include polymerization data using catalyst C1. Dinuclear samples PE-149 through PE-160 include polymerization data using catalyst C6, dinuclear samples PE-161 through PE-172 include polymerization data using catalyst C7, and dinuclear samples PE-173 through PE-184 include polymerization data using catalyst C8.

### Gas Phase Polymerization Processes

In some instances, the polymerization reactions utilizing the disclosed dinuclear tethered catalysts may be performed as a gas phase polymerization reaction. Example gas phase polymerization reactions or processes are described below. It should be noted, in some embodiments the disclosed catalysts may be performed via a solution phase polymerization reaction. Without wishing to be bound by theory, alkylation of the precatalyst occurs in a homogeneous phase, forming an active catalyst that can participate in both gas phase and solution phase olefin polymerization.

Polymerizations were conducted in a two-liter autoclave reactor (e.g., a reactor) (Parker Autoclave Engineers Research Systems) heated to 105° C. under a continuous purge of anhydrous nitrogen gas (about 2-5 SLPM) for 60 minutes. Anhydrous sodium chloride, 150 g (Fisher, oven-dried 48 hours at 180° C., stored under inert atmosphere in glovebox), was loaded into a 0.5 L Whitey cylinder and charged to the reactor with nitrogen pressure. The reactor was maintained at 105° C. with continued nitrogen purge for 30 minutes. A solid scavenger (4 g, sMAO) was loaded to a Whitey sample cylinder and added to the reactor with nitrogen charge. Nitrogen purge was discontinued and the reactor maintained at 105° C. and 70 psig N₂ as an impeller rotated the bed for 30 minutes (about 100-200 RPM). The reactor was adjusted to desired reactor temperature (e.g., 85° C.) and the nitrogen pressure reduced to about 20 psig. Comonomer (2.5 mL of 1-hexene) was charged into the reactor from a syringe pump (Teledyne Isco), followed by 120 mL of 10% hydrogen gas (nitrogen balance). The reactor was subsequently pressurized with ethylene monomer to a total pressure of 240 psig.

In some embodiments, a solid catalyst (e.g., MAO-silica support) is loaded into a small injection tube under inert atmosphere nitrogen in a glovebox. The catalyst injection tube was attached to the reactor and catalyst was charged into the reactor with high pressure nitrogen (300-350 psig), and polymerization was monitored during a predetermined reaction time. The comonomer and hydrogen were continuously added with mass flow controllers to maintain specific concentrations during the polymerization, as measured by GC. Ethylene monomer was continuously added, maintaining a constant total reactor pressure of about 200-230 psig. After the predetermined reaction time, the reactor was vented and cooled to ambient pressure and temperature. A reaction product was collected, dried approximately 60 to 90 minutes under nitrogen purge, and weighed for crude yield. The reaction product was transferred and cleaned to remove sodium chloride and residual silica. One or more polymer samples were collected by filtration and oven dried under vacuum at 40° C. for approximately 12 hours, and the weight was measured to determine a final isolated yield.

As used herein, “EH run #” represents a sample name and number. “Yield” presented in Tables 6 and 7 corresponds to polymer yield not corrected for catalyst residue. Unless otherwise specified, polymerization conditions of results presented in Tables 6 and 7 correspond to about a catalyst complex supported on a solid support with about 40 μmol/g of the activator, approximately 4 g of a scavenger, a bed material of about 150 g NaCl, with a temperature of about 85° C., approximately 120 mL of H₂, a H₂/C₂ ratio of about 0.5, a comonomer (e.g., 1-hexene) of about 2.5 mL, a C₆/C₂ ratio of about 0.1, or a combination thereof.

In general, Table 6 includes runtime, yield, productivity for one or more supported catalysts systems formed from one or more catalysts in combination with one or more supports of a particular supported catalyst weight. As shown, catalyst compounds supported by sMAO-2, sMAO-3, and sMAO-4 have an increased productivity when compared to catalyst compounds supported by sMAO-1. For example, the supported catalyst S1 has a productivity of approximately 585 g/g while the supported catalyst S2 has a productivity ranging between 3000 to 4800 g/g, between 3400 to 4700 g/g, approximately 4600 g/g. For example, the supported catalyst S6 has a productivity of approximately 1000 g/g while the supported catalyst S7 has a productivity ranging between 2000 to 3000 g/g. The supported catalyst S8 has a productivity of approximately 1700 g/g. The supported catalyst S9 has a productivity of approximately 1500 g/g.

Table 7 includes chemical and physical properties of one or more polymerization samples generated using one or more supported catalyst systems. Table 1 includes molecular weights (weight average molecular weight (Mw), number average molecular weight (Mn) and z average molecular weight (Mz)) and molecular weight distribution (MWD=Mw/Mn) (e.g., polydispersity) as measured by Gel Permeation Chromatography. Table 7 also includes comonomer percentage (e.g., comonomer %) and a long chain branching (LCB) index (g′) of the polymerization samples. As shown, catalyst compounds supported by sMAO-2, sMAO-3, and sMAO-4 have an increased molecular weight distribution when compared to catalyst compounds supported by sMAO-1. For example, the supported catalyst S1 has a MWD of approximately 15 while the supported catalyst S2 has an MWD ranging between 13 and 17, approximately 17. For example, the supported catalyst S6 has an MWD of approximately 22 while the supported catalyst S7 has an MWD of approximately 36. The supported catalyst S8 has an MWD of approximately 30. The supported catalyst S9 has a productivity of approximately 29. Without wishing to be bound by theory, sMAO-2, sMAO-3, sMAO-4 may improve polymerization of olefins by improving activation of active sites of the catalyst compounds.

Technical effects of the disclosed embodiments include systems and processes including dinuclear tethered catalysts for olefin polymerization. For example, catalyst compositions disclosed herein are directed to improve catalyst activity. Additionally, and/or alternatively, the one or more catalyst systems described herein may improve molecular weight distributions of polymers generated using said catalysts systems in gas phase polymerization reactions, solution phase polymerization reactions, or a combination thereof. The catalyst systems described herein may include one or more monometallic catalyst-based catalyst system, one or more dinuclear tethered catalysts based catalyst system that may be used to improve olefin polymerization. Further, technical effects of the disclosed embodiments include synthesis and use of supported catalysts systems with improved productivity and increased molecular weight distribution of polymers generated during polymerization driven by the catalysis systems disclosed herein.

While only certain features of disclosed embodiments have been illustrated and described herein, many modifications and changes will occur to those skilled in the art. It is, therefore, to be understood that the appended claims are intended to cover all such modifications and changes as fall within the true spirit of the present disclosure.

1. A catalyst compound represented by Formula (I): 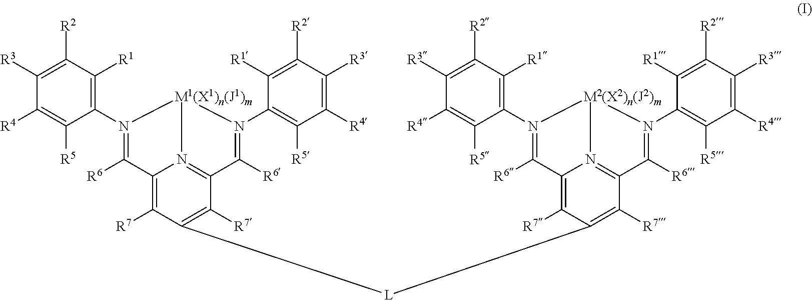
wherein:
M¹ and M² are independently selected from magnesium, vanadium, niobium, tantalum, chromium, manganese, iron, cobalt, zinc, aluminum, gallium or indium;
X¹ and X² are independently an anionic ligand;
J¹ and J² are independently a neutral coordinated ligand bonded to M¹, M² or X;
L is a divalent hydrocarbyl or substituted hydrocarbyl tether;
nis 0, 1, 2 or 3;
m is 0, 1, 2 or 3;
n+m is 1, 2, 3 or 4;
each of R¹, R², R³, R⁴, R⁵, R^{1′}, R^{2′}, R^{3′}, R⁴, R^{5′} R^{1″}, R^{2″}, R^{3″}, R^{4″}, R^{5″}, R^{1″}, R^{2″}, R^{3″}, R^{4′″} and R^{5′″} is independently hydrogen, a C₁-C₂₀ hydrocarbyl, a C₁-C₂₀ substituted hydrocarbyl, a halogen, a heteroatom or a heteroatom-containing group, and optionally one or more of R¹ and R², R^{1′} and R^{2′}, R^{1″} and R^{2″}, R^{1′} and R^{2′″}, R² and R³, R^{2′} and R^{3′}, R^{2″} and R^{3″}, R^{2′″} and R^{3″}, R³ and R⁴, R^{3′} and R^{4′}, R^{3″} and R^{4″}, R^{3′″} and R^{4″}, R⁴ and R⁵, R^{4′} and R^{5′}, R^{4″} and R^{5″}, R^{4″} and R^{5′″} are joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R⁶, R⁷, R^{6′}, R⁷, R^{6″}, R^{7″}, R^{6″}, R^{7″} is independently hydrogen, a C₁-C₂₀ hydrocarbyl, a C₁-C₂₀ substituted hydrocarbyl, a heteroatom or a heteroatom-containing group, and optionally one or more of R⁶ and R⁷, R^{6′} and R⁷, R^{6″} and R^{7″}, R^{6″} and R^{7′″} are joined to form one or more substituted hydrocarbyl rings, unsubstituted hydrocarbyl rings, substituted heterocyclic rings, or unsubstituted heterocyclic rings each having 5, 6, 7, or 8 ring atoms;
optionally any two X¹ are joined together and optionally any two X² are joined together to each form a dianionic bidentate group;
optionally any two J¹ are joined together and optionally any two J² are joined together to each form a neutral bidentate group; and
optionally any X¹ and J¹ are joined together and optionally any two X² and J² are joined together to each form a monoanionic bidentate group.

2. The catalyst compound of claim 1, wherein X¹ and X² are independently a halogen or a C₁-C₂₀ hydrocarbyl optionally comprising heteroatoms.

3. The catalyst compound of claim 1, wherein J¹ and J² are independently a C₁-C₂₀ hydrocarbyl group optionally comprising heteroatoms, or heteroatom containing group.

4. The catalyst compound of claim 1, wherein L is selected from the group consisting of one or more substituted aromatic cyclic hydrocarbyl moieties, one or more substituted aromatic heterocyclic moieties, one or more substituted antiaromatic cyclic hydrocarbyl moieties, one or more substituted antiaromatic heterocyclic moieties, one or more substituted non-aromatic cyclic hydrocarbyl moieties, or one or more substituted non-aromatic heterocyclic moieties.

5. The catalyst compound of claim 1, wherein L confers structural rigidity to the Formula (I), wherein M¹ and M² are proximal to one another.

6. The catalyst compound of claim 1, wherein L is selected from the group represented by the following formulas: 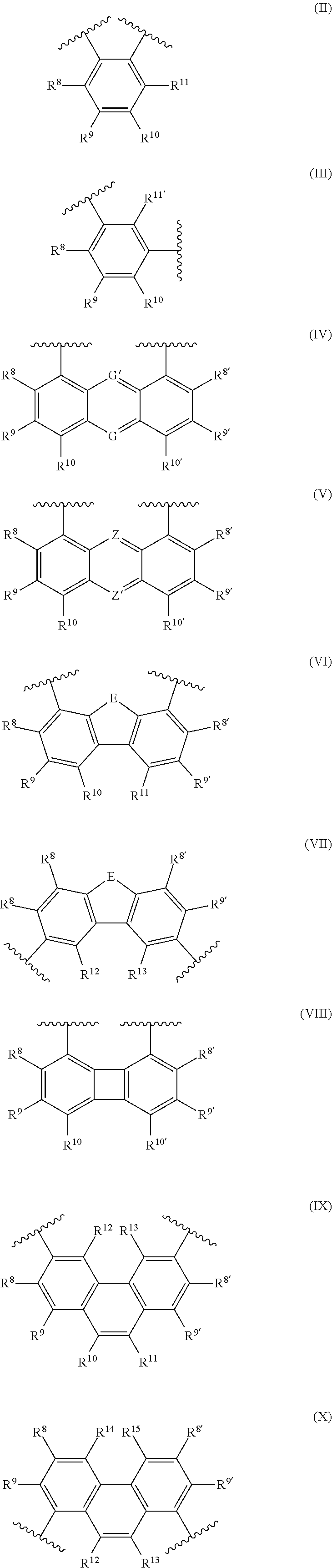
wherein [symbol] denotes a diminopyridine bonding position, wherein:
each of E, Z and Z′ are independently BR, CR₂, SiR₂, NR, PR, PR₃, SbR, SbR₃, O, S, Se or Te;
G and G′ is independently C—R or N;
R is hydrogen, C₁-C₂₀ hydrocarbyl or a C₁-C₂₀ substituted hydrocarbyl, a heteroatom or heteroatom containing group; and
each of R⁸, R^{8′} R⁹, R^{9′}, R¹⁰, R^{10′}, R¹¹, R^{11′}, R¹², R¹³, R¹⁴, and R¹⁵ is independently hydrogen, a C₁-C₂₀ hydrocarbyl, a C₁-C₂₀ substituted hydrocarbyl, a halogen, a heteroatom or a heteroatom-containing group, and optionally one or more of R⁸ and R⁹, R^{8′} and R^{9′}, R⁹ and R¹⁰, R^{9′} and R^{10′}, R¹⁰ and R¹¹, R¹² and R¹³, R⁸ and R¹⁴, R^{8′} and R¹⁵, R^{9′} and R¹¹, R¹⁴ and R¹⁵ are joined to form one or more substituted hydrocarbyl rings, unsubstituted hydrocarbyl rings, substituted heterocyclic rings, or unsubstituted heterocyclic rings each having 5, 6, 7, or 8 ring atoms.

7. The catalyst compound of claim 6, wherein Z and Z′ atoms are independently selected from BR, CR₂, SiR₂, NR, PR, SbR and where an R-group on Z is joined with an R-group on Z′ to form one or more substituted hydrocarbyl rings or one or more unsubstituted hydrocarbyl rings optionally containing heteroatoms, and wherein each of the one or more substituted hydrocarbyl rings or the one or more unsubstituted hydrocarbyl rings comprise 5, 6, 7, or 8 ring atoms.

8. The catalyst compound of claim 1, wherein a calculated metal-metal distances between M¹ and M² is between 5 Å and 16 Å as determined using Density Functional Theory.

9. A catalyst compound of claim 1 wherein:
M¹ and M² are independently selected from iron, vanadium or cobalt;
X is independently a halogen;
L is a divalent hydrocarbyl or substituted hydrocarbyl tether;
m is 0;
nis 1, 2, or 3; and
each of R¹, R², R³, R⁴, R⁵, R⁶, R⁷, R¹, R^{2′}, R^{3′}, R^{4′}, R^{5′}, R^{6′}, R⁷, R^{1″}, R^{2″}, R^{3″}, R^{4″}, R^{5″}, R^{6″}, R^{7′}, R^{1′″}, R^{2″}, R^{3″}, R^{4″}, R^{5″}, R^{6″}, and R^{7′″} is independently hydrogen, a C₁-C₂₀ hydrocarbyl, or a C₁-C₂₀ substituted hydrocarbyl.

10. The catalyst compound of claim 9, wherein M¹ and M² are independently iron or vanadium.

11. The catalyst compound of claim 9, wherein L is selected from Formula II, III, VI, or VII.

12. The catalyst compound of claim 9, wherein L is Formula V.

13. A catalyst system comprising the catalyst compound of claim 1, an activator and optionally a support material.

14. The catalyst system of claim 13, wherein the activator comprises an alkylaluminum selected from a group methylalumoxane (MAO), modified methylalumoxane (MMAO), ethylalumoxane, isobutylalumoxane, diethylaluminum chloride, ethylaluminum sesquichloride, dimethyl aluminum chloride, ionic methylalumoxane (i-MAO) and fluorinated methylalumoxane (F-MAO) or a combination thereof.

15. The catalyst system of claim 14, wherein the alkylaluminum is present at a molar ratio of aluminum to catalyst compound of at least 50:1.

16. The catalyst system of claim 13, wherein the support material is selected from Al₂O₃, ZrO₂, SiO₂, TiO₂, silica clay, silicon oxide/clay, or mixtures thereof.

17. A catalyst system of claim 13, comprising one or more additional catalyst compounds.

18. The catalyst system of claim 17, wherein the one or more additional catalyst compounds comprises a metallocene catalyst compound, a post-metallocene catalyst compound, or a constrained geometry catalyst compound.

19. A method of polymerizing olefins to produce a polyolefin comprising contacting ethylene and optionally at least one or more C₃-C₂₀ olefins with the catalyst system of claim 13.

20. The method of polymerizing olefins of claim 19, wherein polymerization occurs in a gas phase reactor, a slurry phase reactor, or a solution phase reactor.

21. A catalyst system comprising:
a catalyst compound, wherein the catalyst compound is a monometallic catalyst compound represented by Formula (XI) 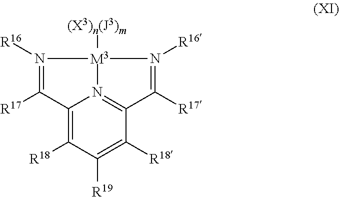
wherein:
M³ is selected from magnesium, vanadium, niobium, tantalum, chromium, manganese, iron, cobalt, zinc, aluminum, gallium or indium;
R¹⁶ and R^{16′} is selected from a substituted hydrocarbyl, a heteroatom or a heteroatom-containing group, one or more substituted hydrocarbyl rings, unsubstituted hydrocarbyl rings, substituted heterocyclic rings, or unsubstituted heterocyclic rings each having 5, 6, 7, or 8 ring atoms;
R¹⁷, R^{17′}, R¹⁸, R^{18′} and R¹⁹ are selected from a substituted hydrocarbyl, a heteroatom or a heteroatom-containing group, or a combination thereof, wherein R¹⁷ and R¹⁸, R¹⁷ and R^{18′}, R¹⁸ and R¹⁹, R^{18′} and R¹⁹ are optionally joined to form one or more substituted hydrocarbyl rings, unsubstituted hydrocarbyl rings, substituted heterocyclic rings, or unsubstituted heterocyclic rings, and wherein a heterocyclic rings optionally include 5, 6, 7, or 8 ring atoms;
X³ is selected from one or more substituted hydrocarbyls or one or more halogen; and
J³ is a neutral coordinated ligand bonded to M³ or X³; and
an activator, wherein the activator is selected from a group comprising: a fluorinated methylaluminoxane (F-MAO) activator or an ionic methylaluminoxane (i-MAO) activator; and optionally a support.

22. A catalyst system of claim 21, further comprising one or more additional catalysts selected from the group consisting of: a metallocene catalyst compound, a post-metallocene catalyst compound, and a constrained geometry catalyst compound.
